(19) United States
(12) Patent Application Publication
(10) Pub. No.: US 2024/0395056 A1
(43) Pub. Date: Nov. 28, 2024

(54) DRIVER SURVEILLANCE APPARATUS, DRIVER SURVEILLANCE METHOD, AND NON-TRANSITORY STORAGE MEDIUM

(71) Applicant: NEC Corporation, Minato-ku, Tokyo (JP)

(72) Inventors: Haruka FUJIWARA, Tokyo (JP); Jianquan LIU, Tokyo (JP); Nobuo FUWA, Tokyo (JP)

(73) Assignee: NEC Corporation, Minato-ku, Tokyo (JP)

(21) Appl. No.: 18/695,065

(22) PCT Filed: Oct. 6, 2021
(86) PCT No.: PCT/JP2021/036988

§ 371 Date: Mar. 25, 2024

(51) Int. Cl. G06V 20/59; G06T 7/70; G06V 10/40; G06V 40/20

(52) U.S. Cl. CPC G06V 20/597; G06T 7/70; G06V 10/40; G06V 40/20

(57) ABSTRACT

The present invention provides a driver surveillance apparatus (10) including: an image acquisition unit (11) that acquires an image in which a driver of a moving body is captured; a first detection unit (12) that extracts feature data about a body of the driver captured in the image, verifies the extracted feature data with reference data, and thus detects at least one of a predetermined pose and a predetermined movement; a second detection unit (13) that detects a predetermined object from the image; and a third detection unit (14) that detects predetermined behavior of the driver, based on a detection result of at least one of the predetermined pose and the predetermined movement and a detection result of the predetermined object.

### TECHNICAL FIELD

The present invention relates to a driver surveillance apparatus, a driver surveillance method, and a program.

### BACKGROUND ART

Patent Document 1 discloses a technique for detecting a smoking action, a water drinking action, an eating action, a phone calling action, an entertainment action, and the like by a driver. NPL 1 discloses a technique related to skeleton estimation of a person.

### RELATED DOCUMENT

### Patent Document

Patent Document 1: Japanese Patent Application Publication (Translation of PCT Application) No. 2019-536673

### Non-Patent Document

[Non-Patent Document 1] Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### DISCLOSURE OF THE INVENTION

### Technical Problem

The present invention has a challenge to detect predetermined behavior of a driver with high accuracy.

### Solution to Problem

The present invention provides a driver surveillance apparatus including:
an image acquisition unit that acquires an image in which a driver of a moving body is captured;
a first detection unit that extracts feature data about a body of the driver captured in the image, verifies the extracted feature data with reference data, and thus detects at least one of a predetermined pose and a predetermined movement;
a second detection unit that detects a predetermined object from the image; and
a third detection unit that detects predetermined behavior of the driver, based on a detection result of at least one of the predetermined pose and the predetermined movement and a detection result of the predetermined object.

Further, the present invention provides a driver surveillance method being executed by a computer and including:
an image acquisition step of acquiring an image in which a driver of a moving body is captured;
a first detection step of extracting feature data about a body of the driver captured in the image, verifying the extracted feature data with reference data, and thus detecting at least one of a predetermined pose and a predetermined movement;
a second detection step of detecting a predetermined object from the image; and
a third detection step of detecting predetermined behavior of the driver, based on a detection result of at least one of the predetermined pose and the predetermined movement and a detection result of the predetermined object.

Further, the present invention provides a program causing a computer to function as:
an image acquisition unit that acquires an image in which a driver of a moving body is captured;
a first detection unit that extracts feature data about a body of the driver captured in the image, verifies the extracted feature data with reference data, and thus detects at least one of a predetermined pose and a predetermined movement;
a second detection unit that detects a predetermined object from the image; and
a third detection unit that detects predetermined behavior of the driver, based on a detection result of at least one of the predetermined pose and the predetermined movement and a detection result of the predetermined object.

### Advantageous Effects of Invention

According to the present invention, predetermined behavior of a driver can be detected with high accuracy.

### BRIEF DESCRIPTION OF THE DRAWINGS

The above-described object, the other objects, features, and advantages will become more apparent from suitable example embodiment described below and the following accompanying drawings.

FIG. 1 It is a diagram illustrating one example of a hardware configuration of a driver surveillance apparatus according to the present example embodiment.

FIG. 2 It is a diagram illustrating one example of a functional block diagram of the driver surveillance apparatus according to the present example embodiment.

FIG. 3 It is a diagram schematically illustrating one example of information processed by the driver surveillance apparatus according to the present example embodiment.

FIG. 4 It is a diagram schematically illustrating one example of information processed by the driver surveillance apparatus according to the present example embodiment.

FIG. 5 It is a diagram schematically illustrating one example of information processed by the driver surveillance apparatus according to the present example embodiment.

FIG. 6 It is a flowchart illustrating one example of a flow of processing of the driver surveillance apparatus according to the present example embodiment.

FIG. 7 It is a diagram illustrating one example of a functional block diagram of the driver surveillance apparatus according to the present example embodiment.

FIG. 8 It is a flowchart illustrating one example of a flow of processing of the driver surveillance apparatus according to the present example embodiment.

FIG. 9 It is a diagram illustrating one example of a functional block diagram of the driver surveillance apparatus according to the present example embodiment.

FIG. 10 It is a diagram illustrating one example of a functional block diagram of the driver surveillance apparatus and a server according to the present example embodiment.

FIG. 11 It is a diagram illustrating one example of a functional block diagram of the driver surveillance apparatus according to the present example embodiment.

FIG. 12 It is a diagram illustrating one example of a functional block diagram of the driver surveillance apparatus according to the present example embodiment.

FIG. 13 It is a diagram illustrating one example of a functional block diagram of an image processing apparatus according to the present example embodiment.

FIG. 14 It is a diagram illustrating one example of a functional block diagram of the image processing apparatus according to the present example embodiment.

FIG. 15 It is a flowchart illustrating one example of a flow of processing of the image processing apparatus according to the present example embodiment.

FIG. 16 It is a flowchart illustrating one example of a flow of processing of the image processing apparatus according to the present example embodiment.

FIG. 17 It is a flowchart illustrating one example of a flow of processing of the image processing apparatus according to the present example embodiment.

FIG. 18 It is a diagram illustrating a detection example of a skeleton structure.

FIG. 19 It is a diagram illustrating a human model.

FIG. 20 It is a diagram illustrating a detection example of the skeleton structure.

FIG. 21 It is a diagram illustrating a detection example of the skeleton structure.

FIG. 22 It is a diagram illustrating a detection example of the skeleton structure.

FIG. 23 It is a graph illustrating a specific example of a classification method.

FIG. 24 It is a diagram illustrating a display example of a classification result.

FIG. 25 It is a diagram for describing a search method.

FIG. 26 It is a diagram for describing the search method.

FIG. 27 It is a diagram for describing the search method.

FIG. 28 It is a diagram for describing the search method.

FIG. 29 It is a diagram illustrating one example of a functional block diagram of the image processing apparatus according to the present example embodiment.

FIG. 30 It is a flowchart illustrating one example of a flow of processing of the image processing apparatus according to the present example embodiment.

FIG. 31 It is a flowchart illustrating one example of a flow of processing of the image processing apparatus according to the present example embodiment.

FIG. 32 It is a flowchart illustrating one example of a flow of processing of the image processing apparatus according to the present example embodiment.

FIG. 33 It is a flowchart illustrating one example of a flow of processing of the image processing apparatus according to the present example embodiment.

FIG. 34 It is a flowchart illustrating one example of a flow of processing of the image processing apparatus according to the present example embodiment.

FIG. 35 It is a diagram illustrating a human model.

FIG. 36 It is a diagram illustrating a detection example of the skeleton structure.

FIG. 37 It is a diagram illustrating a detection example of the skeleton structure.

FIG. 38 It is a diagram illustrating a detection example of the skeleton structure.

FIG. 39 It is a diagram illustrating a human model.

FIG. 40 It is a diagram illustrating a detection example of the skeleton structure.

FIG. 41 It is a histogram for describing a height pixel number computation method.

FIG. 42 It is a diagram illustrating a detection example of the skeleton structure.

FIG. 43 It is a diagram illustrating a three-dimensional human model.

FIG. 44 It is a diagram for describing the height pixel number computation method.

FIG. 45 It is a diagram for describing the height pixel number computation method.

FIG. 46 It is a diagram for describing the height pixel number computation method.

FIG. 47 It is a diagram for describing a normalization method.

FIG. 48 It is a diagram for describing the normalization method.

FIG. 49 It is a diagram for describing the normalization method.

### DESCRIPTION OF EMBODIMENTS

Hereinafter, example embodiments of the present invention will be described by using drawings. Note that, in all of the drawings, a similar component has a similar reference sign, and description thereof will be appropriately omitted.

### First Example Embodiment

### “Overview”

A driver surveillance apparatus according to the present example embodiment analyzes an image in which a driver is captured, and detects at least one of a predetermined pose and a predetermined movement being preset of the driver and a predetermined object being preset. Hereinafter, “at least one of a pose and a movement” may be referred to as a “pose and the like”. A predetermined pose and the like being preset of a driver are a pose and the like of the driver when the driver performs predetermined behavior. A predetermined object being preset is an object used by a driver when the driver performs predetermined behavior. Then, the driver surveillance apparatus detects the predetermined behavior of the driver, based on a detection result of the predetermined pose and the like of the driver and a detection result of the predetermined object.

### “Hardware Configuration”

Next, one example of a hardware configuration of the driver surveillance apparatus will be described. Each functional unit of the driver surveillance apparatus is achieved by any combination of hardware and software concentrating on a central processing unit (CPU) of any computer, a memory, a program loaded into the memory, a storage unit (that can also store a program downloaded from a storage medium such as a compact disc (CD), a server on the Internet, and the like in addition to a program previously stored at a stage of shipping of an apparatus) such as a hard disk that stores the program, and a network connection interface. Then, various modification examples of an achievement method and an apparatus thereof are understood by a person skilled in the art.

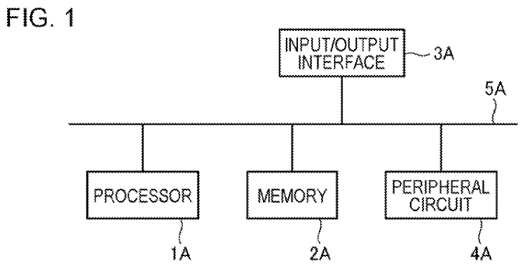

FIG. 1 is a block diagram illustrating a hardware configuration of the driver surveillance apparatus. As illustrated in FIG. 1, the driver surveillance apparatus includes a processor 1A, a memory 2A, an input/output interface 3A, a peripheral circuit 4A, and a bus 5A. Various modules are included in the peripheral circuit 4A. The driver surveillance apparatus may not include the peripheral circuit 4A. Note that, the driver surveillance apparatus may be formed of a plurality of apparatuses being separated physically and/or logically. In this case, each of the plurality of apparatuses can include the hardware configuration described above.

The bus 5A is a data transmission path for the processor 1A, the memory 2A, the peripheral circuit 4A, and the input/output interface 3A to transmit and receive data to and from one another. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can output an instruction to each of modules, and perform an arithmetic operation, based on an arithmetic result of the modules.

### “Functional Configuration”

Next, a functional configuration of the driver surveillance apparatus will be described. The driver surveillance apparatus is an apparatus that detects predetermined behavior of a driver. The driver surveillance apparatus according to the present example embodiment may be an apparatus mounted on a moving body, or an external server configured to be communicable with an apparatus mounted on a moving body.

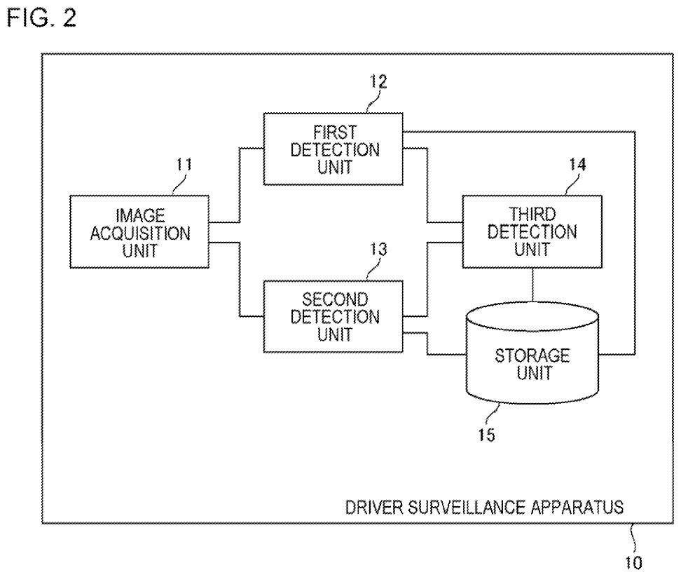

FIG. 2 is one example of a functional block diagram of a driver surveillance apparatus 10. As illustrated, the driver surveillance apparatus 10 includes an image acquisition unit 11, a first detection unit 12, a second detection unit 13, a third detection unit 14, and a storage unit 15. Note that, the driver surveillance apparatus 10 may not include the storage unit 15. In this case, an external apparatus configured to be accessible from the driver surveillance apparatus 10 includes the storage unit 15.

The image acquisition unit 11 acquires an image in which a driver of a moving body is captured.

The “moving body” is an object that moves in response to an operation of a driver, and a car, a bus, a train, a bicycle, an airplane, a ship, and the like are exemplified, which are not limited thereto.

In the present example embodiment, a camera is installed on a moving body in a position and an orientation in which a driver is captured. The camera preferably captures a moving image, but may successively capture a still image at predetermined time intervals, or may capture a single still image and the like. The camera may be able to recognizably capture a predetermined object described below such as a pose of a driver, and various cameras such as a visible light camera and a near infrared camera can be adopted.

The image acquisition unit 11 acquires an image generated by the camera as described above. The image acquisition unit 11 preferably acquires an image generated by the camera in real time. For example, the camera installed on a moving body and the driver surveillance apparatus 10 may be communicably connected to each other. Alternatively, an apparatus (such as an electronic control unit (ECU)) that collects data of the camera installed on a moving body and the driver surveillance apparatus 10 may be communicably connected to each other. Then, the driver surveillance apparatus 10 acquires an image generated by the camera from the apparatus in real time.

The first detection unit 12 extracts feature data about a body of a driver captured in the image acquired by the image acquisition unit 11, and detects at least one of a predetermined pose and a predetermined movement by performing feature data matching that verifies the extracted feature data with reference data.

The “predetermined pose and the predetermined movement” are a pose and a movement of a driver when the driver performs predetermined behavior while driving. For example, a “pose for putting a hand on a side of a face (pose during a call with a cellular phone and the like)”, a “pose for operating a cellular phone and the like while viewing a screen”, a “pose for holding a magazine or a book with a hand for reading”, a “pose for holding a newspaper with a hand for reading”, a “movement for eating food held with a hand”, a “movement for drinking a drink held with a hand”, a “movement for taking out a cigarette from a case”, a “movement for lighting a cigarette”, and the like are exemplified, which are not limited thereto.

The “predetermined behavior” is behavior that is not preferable for a driver to perform during driving, and forbidden behavior such as, for example, a “call using a cellular phone”, an “operation on a cellular phone”, an “act of reading a magazine, a book, a newspaper, and the like”, an “act of eating”, an “act of drinking”, an “act of taking out a cigarette from a case”, and an “act of lighting a cigarette” is exemplified, which is not limited thereto.

The “reference data” are feature data about a body of a person when the person performs a predetermined pose or a predetermined movement. A movement can be indicated by, for example, a time change in feature data about a body of a person. The reference data are stored in advance in the storage unit 15.

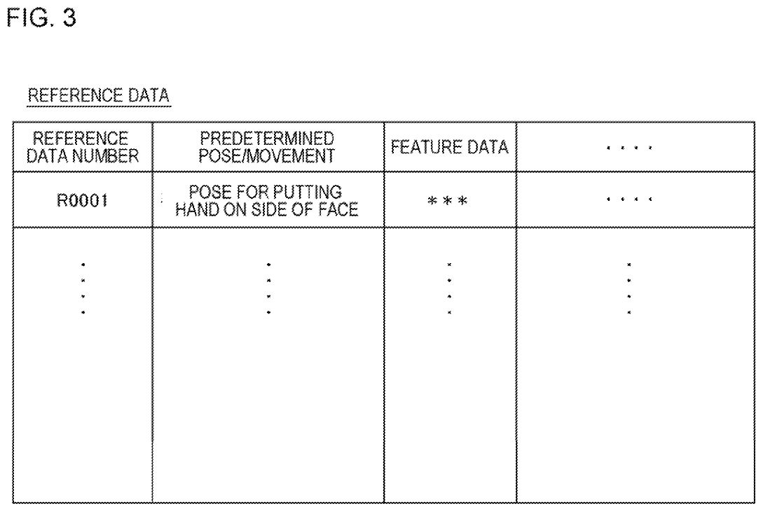

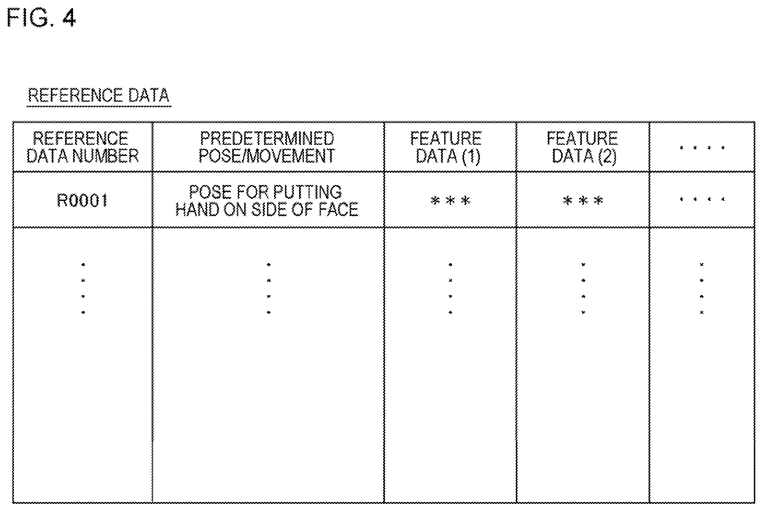

FIG. 3 illustrates one example of the reference data. In the illustrated example, feature data about a pose for putting a hand on a side of a face are registered. Note that, as illustrated in FIG. 4, a plurality of pieces of feature data may be registered for one pose or one movement. Even for the same pose (for example, a pose for putting a hand on a side of a face), a difference by gender, age, a build, a structure of a moving body being driven, and the like may be present. A predetermined pose and a predetermined movement can be accurately detected by registering a plurality of variations of feature data in association with one pose and one movement.

Note that, processing by the first detection unit 12 will be described in more detail in the following example embodiment.

Returning to FIG. 2, the second detection unit 13 detects a predetermined object from the image acquired by the image acquisition unit 11.

The “predetermined object” is an object used by a driver when the driver performs predetermined behavior. For example, as the predetermined object, a cellular phone, a smartphone, a tablet terminal, a newspaper, a book, a magazine, a cigarette, a lighter, a match, a drink, food, and the like are exemplified, which are not limited thereto.

Detection of the object by the second detection unit 13 can be achieved by using every conventional technique such as a neural network and pattern matching. The storage unit 15 stores data needed for object detection using the technique.

The third detection unit 14 detects predetermined behavior by the driver, based on a detection result of the predetermined pose and the like by the first detection unit 12 and a detection result of the predetermined object by the second detection unit 13.

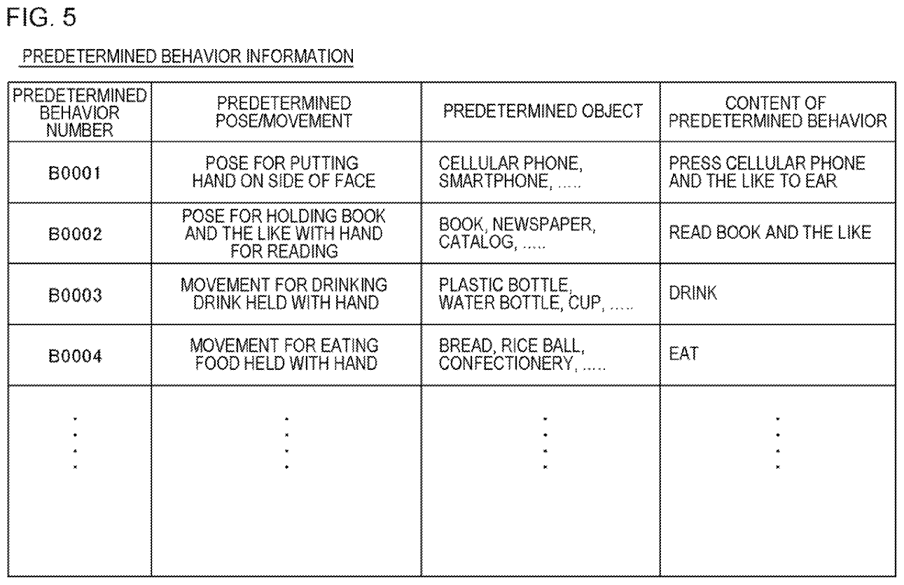

For example, as illustrated in FIG. 5, predetermined behavior information in which a pose and the like of a driver when the driver performs predetermined behavior and a predetermined object used by the driver when the driver performs the predetermined behavior are associated with each other for each piece of the predetermined behavior of the driver is stored in advance in the storage unit 15. Then, the third detection unit 14 refers to the predetermined behavior information, and detects predetermined behavior of the driver. Specifically, the third detection unit 14 detects predetermined behavior of the driver, based on whether a pair of a pose and the like of the driver being detected by the first detection unit 12 and a predetermined object being detected by the second detection unit 13 is registered as predetermined behavior in the predetermined behavior information as illustrated in FIG. 5.

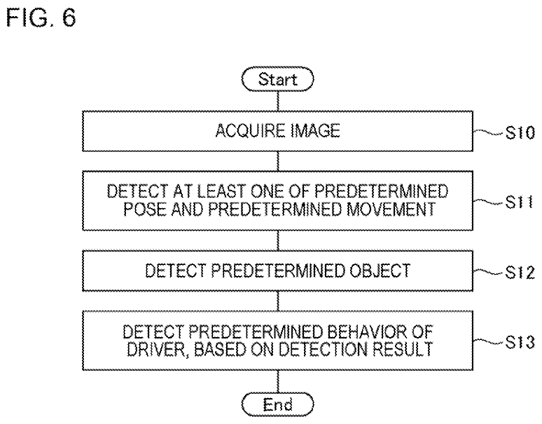

Next, one example of a flow of processing of the driver surveillance apparatus 10 will be described by using a flowchart in FIG. 6.

First, the driver surveillance apparatus 10 acquires an image in which a driver of a moving body is captured (S10).

Subsequently, the driver surveillance apparatus 10 extracts feature data about a body of the driver captured in the image acquired in S10, and detects at least one of a predetermined pose and a predetermined movement by performing feature data matching that verifies the extracted feature data with reference data (S11). Further, the driver surveillance apparatus 10 detects a predetermined object from the image acquired in S10 (S12). Note that, S11 and S12 may be performed in the order illustrated in FIG. 6, may be performed in the reverse order, or may be performed simultaneously.

Subsequently, the driver surveillance apparatus 10 detects predetermined behavior of the driver, based on a detection result of at least one of the predetermined pose and the predetermined movement in S11 and a detection result of the predetermined object in S12 (S13).

Note that, although not illustrated, when the predetermined behavior of the driver is detected in S13, the driver surveillance apparatus 10 may output a warning to the driver. The warning is achieved via a speaker installed on a moving body, a display, a lamp, a vibrator installed on a seat or a handle of a moving body, and the like.

Further, although not illustrated, when the predetermined behavior of the driver is detected in S13, the driver surveillance apparatus 10 may register the predetermined behavior in association with identification information about the driver as a predetermined behavior history. In addition, when the predetermined behavior of the driver is detected in S13, the driver surveillance apparatus 10 may transmit, to an external server, the predetermined behavior in association with identification information about the driver as a predetermined behavior history. The predetermined behavior history indicates, for example, a date and time at which the predetermined behavior is detected, a content of the detected predetermined behavior, and the like. For example, driving of a driver can be evaluated by using information accumulated in such a manner. Note that, identification of a driver can be achieved by using every conventional technique such as face recognition using an image.

### “Advantageous Effect”

The driver surveillance apparatus 10 according to the present example embodiment detects predetermined behavior of a driver, based on a detection result of a pose and the like of the driver when the driver performs the predetermined behavior and a detection result of a predetermined object used by the driver when the driver performs the predetermined behavior. Such a driver surveillance apparatus 10 can detect predetermined behavior of a driver with high accuracy.

### Second Example Embodiment

A driver surveillance apparatus 10 according to the present example embodiment detects predetermined behavior of a driver, based on further data generated by a sensor installed on a moving body in addition to a detection result of a pose and the like of the driver when the driver performs the predetermined behavior and a detection result of a predetermined object used by the driver when the driver performs the predetermined behavior.

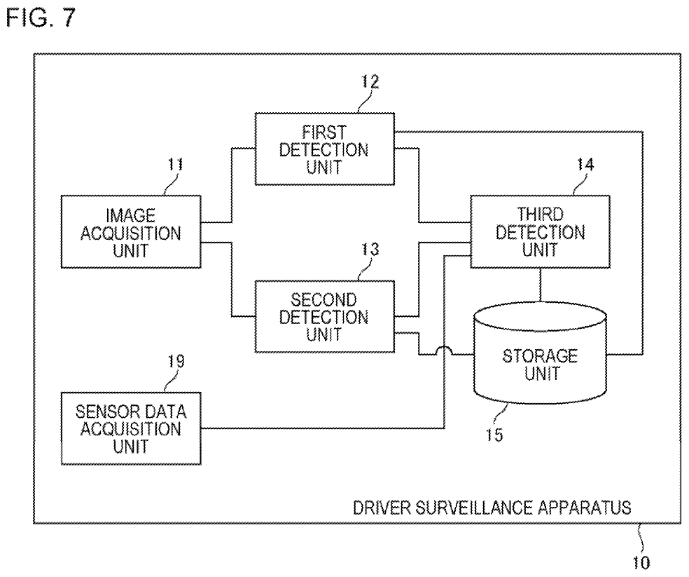

FIG. 7 illustrates one example of a functional block diagram of the driver surveillance apparatus 10 according to the present example embodiment. As illustrated, the driver surveillance apparatus 10 according to the present example embodiment is different from the first example embodiment in a point that the driver surveillance apparatus 10 according to the present example embodiment includes a sensor data acquisition unit 19.

The sensor data acquisition unit 19 acquires data generated by a center installed on a moving body.

As the “sensor”, a sensor that detects a holding state of a handle, a sensor (such as a velocity sensor, an acceleration sensor, and an accelerator sensor) that generates data that can determine whether a moving body is moving, and the like are exemplified, which are not limited thereto.

The sensor data acquisition unit 19 acquires data generated by the sensor as described above. The sensor data acquisition unit 19 preferably acquires data generated by the sensor in real time. For example, the sensor installed on a moving body and the driver surveillance apparatus 10 may be communicably connected to each other. Alternatively, an apparatus (such as an ECU) that collects data of the sensor installed on a moving body and the driver surveillance apparatus 10 may be communicably connected to each other. Then, the driver surveillance apparatus 10 acquires the data generated by the sensor from the apparatus in real time.

A third detection unit 14 detects predetermined behavior of a driver, based on a detection result of a predetermined pose and the like by a first detection unit 12, a detection result of a predetermined object by a second detection unit 13, and data of a sensor acquired by the sensor data acquisition unit 19.

For example, the third detection unit 14 may detect a state where both of the following two conditions are satisfied as a state where a driver performs predetermined behavior.
Data of a sensor satisfies a predetermined condition.
A pair of a pose and the like of a driver being detected by the first detection unit 12 and a predetermined object being detected by the second detection unit 13 is registered as predetermined behavior in the predetermined behavior information as illustrated in FIG. 5.

The predetermined condition of data of a sensor may include at least one of a “handle is not held with both hands” and a “moving body is not stopped”.

When a handle is held with both hands, there is a low possibility that predetermined behavior such as a “call using a cellular phone”, an “operation on a cellular phone”, an “act of reading a magazine, a book, a newspaper, and the like”, an “act of eating”, an “act of drinking”, an “act of taking out a cigarette from a case”, and an “act of lighting a cigarette” is performed. With a configuration in which predetermined behavior of a driver is detected when a condition that a “handle is not held with both hands” is satisfied, an inconvenience that the third detection unit 14 detects the predetermined behavior by mistake when a driver does not perform the predetermined behavior can be reduced.

Further, when a moving body is stopped, behavior such as a “call using a cellular phone”, an “operation on a cellular phone”, an “act of reading a magazine, a book, a newspaper, and the like”, an “act of eating”, an “act of drinking”, an “act of taking out a cigarette from a case”, and an “act of lighting a cigarette” may be permitted. With a configuration in which predetermined behavior of a driver is detected when a condition that a “moving body is not stopped” is satisfied, an inconvenience that the third detection unit 14 unnecessarily detects predetermined behavior when the behavior is permitted can be reduced.

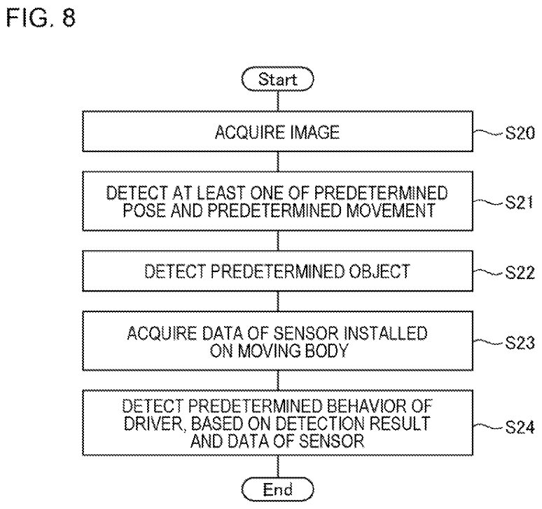

Next, one example of a flow of processing of the driver surveillance apparatus 10 will be described by using a flowchart in FIG. 8.

First, the driver surveillance apparatus 10 acquires an image in which a driver of a moving body is captured (S20).

Subsequently, the driver surveillance apparatus 10 extracts feature data about a body of the driver captured in the image acquired in S20, and detects at least one of a predetermined pose and a predetermined movement by performing feature data matching that verifies the extracted feature data with reference data (S21). Further, the driver surveillance apparatus 10 detects a predetermined object from the image acquired in S20 (S22). Further, the driver surveillance apparatus 10 acquires data generated by a sensor installed on a moving body (S23). Note that, S21, S22, and S23 may be performed in the order illustrated in FIG. 8, may be performed in the other order, or may be performed simultaneously.

Subsequently, the driver surveillance apparatus 10 detects predetermined behavior of the driver, based on a detection result of at least one of the predetermined pose and the predetermined movement in S21, a detection result of the predetermined object in S22, and the data of the sensor acquired in S23 (S24).

Note that, although not illustrated, when the predetermined behavior of the driver is detected in S24, the driver surveillance apparatus 10 may output a warning to the driver. The warning is achieved via a speaker installed on a moving body, a display, a lamp, a vibrator installed on a seat or a handle of a moving body, and the like.

Further, although not illustrated, when the predetermined behavior of the driver is detected in S24, the driver surveillance apparatus 10 may register the predetermined behavior in association with identification information about the driver as a predetermined behavior history. In addition, when the predetermined behavior of the driver is detected in S24, the driver surveillance apparatus 10 may transmit, to an external server, the predetermined behavior in association with identification information about the driver as a predetermined behavior history. The predetermined behavior history indicates, for example, a date and time at which the predetermined behavior is detected, a content of the detected predetermined behavior, and the like. For example, driving of a driver can be evaluated by using information accumulated in such a manner. Note that, identification of a driver can be achieved by using every conventional technique such as face recognition using an image.

Another configuration of the driver surveillance apparatus 10 according to the present example embodiment is similar to that in the first example embodiment.

As described above, the driver surveillance apparatus 10 according to the present example embodiment can achieve an advantageous effect similar to that in the first example embodiment. Further, the driver surveillance apparatus 10 according to the present example embodiment detects predetermined behavior of a driver, based on a detection result of at least one of a pose and a movement of the driver when the driver performs the predetermined behavior, a detection result of a predetermined object used by the driver when the driver performs the predetermined behavior, and data of a sensor installed on a moving body. Such a driver surveillance apparatus 10 can detect predetermined behavior of a driver with high accuracy.

### Third Example Embodiment

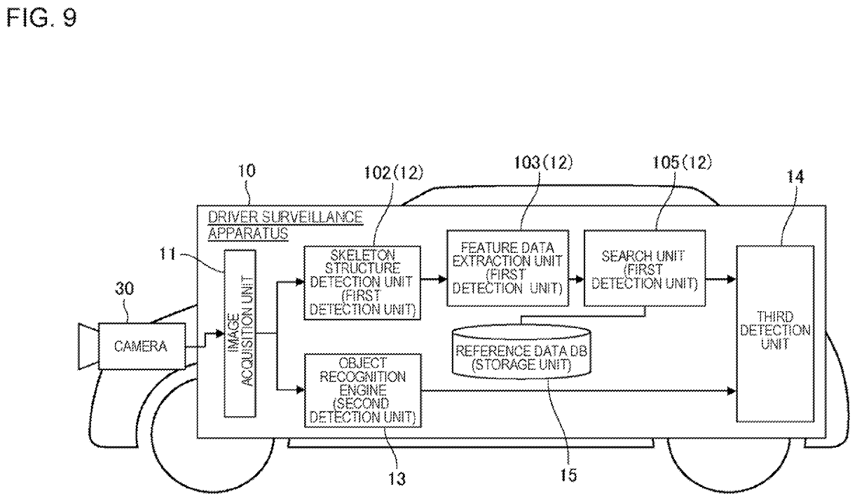

FIG. 9 illustrates a configuration example of a driver surveillance apparatus 10 according to the present example embodiment. As illustrated, the driver surveillance apparatus 10 according to the present example embodiment is mounted on a moving body. An illustrated camera 30 is a camera that captures a driver. The camera 30 is also mounted on a moving body.

Another configuration of the surveillance apparatus 10 according to the present example embodiment is similar to that in the first and second example embodiments.

As described above, the driver surveillance apparatus 10 according to the present example embodiment can achieve an advantageous effect similar to that in the first and second example embodiments. Further, as illustrated in FIG. 9, according to the driver surveillance apparatus 10 in the present example embodiment, the camera 30, an image acquisition unit 11, a first detection unit 12, a second detection unit 13, a third detection unit 14, and a storage unit 15 are achieved in the driver surveillance apparatus 10 mounted on a moving body. Thus, even in an off-line state where the driver surveillance apparatus 10 and an external apparatus are not communicably connected to each other, the driver surveillance apparatus 10 can perform the processing of detecting predetermined behavior of a driver described above.

### Fourth Example Embodiment

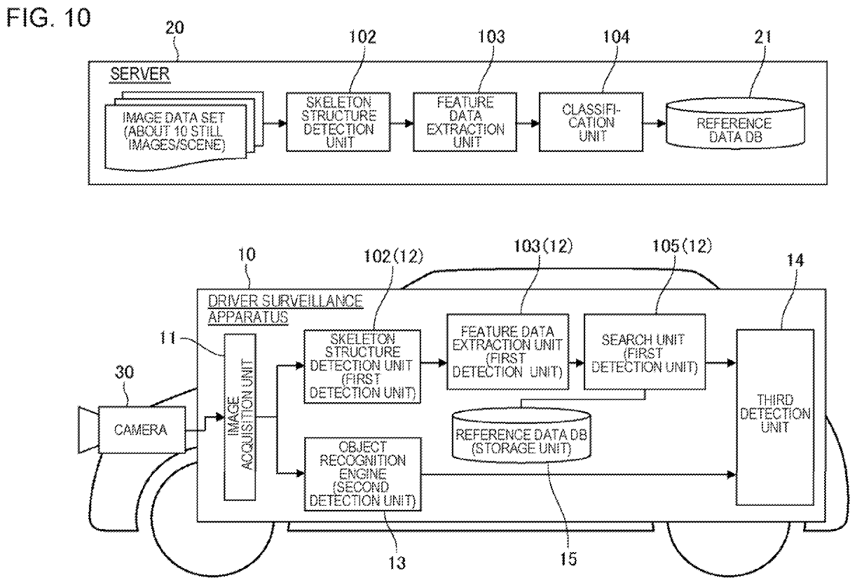

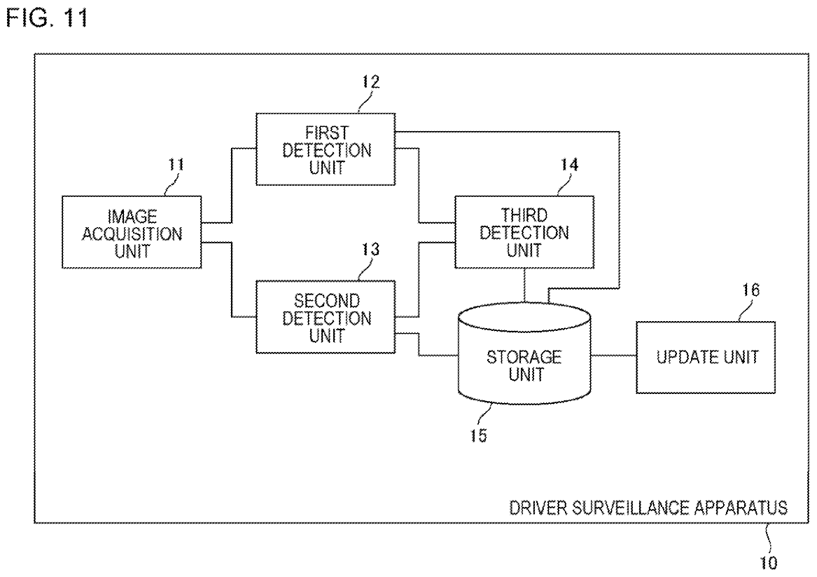

FIG. 10 illustrates a configuration example of a driver surveillance apparatus 10 according to the present example embodiment. Further, FIG. 11 illustrates one example of a functional block diagram of the driver surveillance apparatus 10 according to the present example embodiment. As illustrated in FIG. 11, the driver surveillance apparatus 10 is different from the first to third example embodiments in a point that the driver surveillance apparatus 10 includes an update unit 16. Note that, although not illustrated in FIG. 11, the driver surveillance apparatus 10 may include a sensor data acquisition unit 19.

As illustrated in FIG. 10, the driver surveillance apparatus 10 according to the present example embodiment is mounted on a moving body. Then, a server 20 installed at a place different from that of the moving body generates reference data described above. The server 20 includes a skeleton structure detection unit 102, a feature data extraction unit 103, a classification unit 104, and a reference data database (DB) 21.

First, an image indicating a predetermined pose and the like is input to the skeleton structure detection unit 102. The skeleton structure detection unit 102 detects a two-dimensional skeleton structure of a person in the image, based on the input image. The feature data extraction unit 103 extracts feature data about the detected two-dimensional skeleton structure. The classification unit 104 classifies (performs clustering on) a plurality of the skeleton structures extracted by the feature data extraction unit 103, based on a degree of similarity between the pieces of feature data about the skeleton structures, and stores the plurality of skeleton structures in the reference data DB 21. The configuration of the skeleton structure detection unit 102, the feature data extraction unit 103, and the classification unit 104 will be described in detail in the following example embodiment.

The reference data stored in the reference data DB 21 are input to the driver surveillance apparatus 10 by any means. The update unit 16 receives an input of the reference data by any means, and stores the additional reference data in a storage unit 15. After the reference data are added, a first detection unit 12 also sets, as a verification target of feature data matching described above, the added reference data in addition to reference data originally present in the storage unit 15.

There are various means for receiving an input of additional reference data by the update unit 16, and every means can be adopted. For example, an over the air (OTA) technique may be used, or the other communication technique may be used and reference data may be transmitted from the server 20 to the driver surveillance apparatus 10. In addition, another communication terminal (such as a personal computer, a smartphone, and a tablet terminal) of a user may access the server 20, and reference data may be downloaded at once in the another communication terminal. Then, the another communication terminal and the driver surveillance apparatus 10 may be connected to each other by any means in a wired and/or wireless manner, and the reference data stored in the another communication terminal may be moved to the driver surveillance apparatus 10. In addition, the reference data stored in the another communication terminal may be moved to the driver surveillance apparatus 10 via any portable storage apparatus such as a USB memory and an SD card.

Another configuration of the surveillance apparatus 10 according to the present example embodiment is similar to that in the first to third example embodiments.

As described above, the driver surveillance apparatus 10 according to the present example embodiment can achieve an advantageous effect similar to that in the first to third example embodiments. Further, according to the driver surveillance apparatus 10 in the present example embodiment, reference data generated in the server 20 can be added to the storage unit 15 of the driver surveillance apparatus 10. After the reference data are added, the driver surveillance apparatus 10 also sets, as a verification target of the feature data matching described above, the added reference data in addition to reference data originally present in the storage unit 15.

Such a driver surveillance apparatus 10 according to the present example embodiment can expand a predetermined pose and a predetermined movement by a simple operation of adding reference data to the storage unit 15.

### Fifth Example Embodiment

In the present example embodiment, a driver surveillance apparatus 10 has the configuration in FIG. 10 described in the fourth example embodiment, and further has a function of receiving a user input indicating whether predetermined behavior is correct when the predetermined behavior of a driver is detected, and transmitting, as an image indicating the predetermined behavior, an image used for the detection of the predetermined behavior to a server 20 when the user input indicating that the predetermined behavior is correct is received.

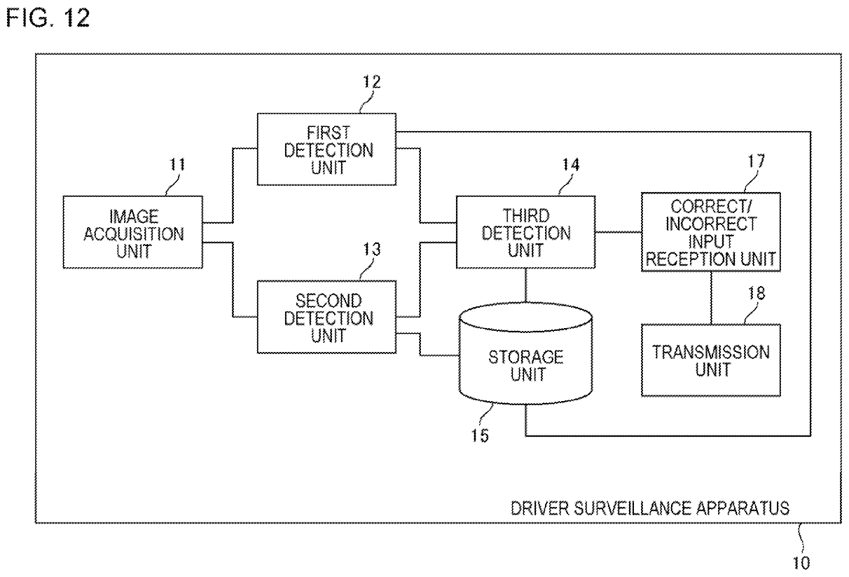

FIG. 12 illustrates one example of a functional block diagram of the driver surveillance apparatus 10 according to the present example embodiment. As illustrated in FIG. 12, the driver surveillance apparatus 10 is different from the first to fourth example embodiments in a point that the driver surveillance apparatus 10 includes a correct/incorrect input reception unit 17 and a transmission unit 18. Note that, although not illustrated in FIG. 12, the driver surveillance apparatus 10 may include at least one of an update unit 16 and a sensor data acquisition unit 19.

When predetermined behavior of a driver is detected, the correct/incorrect input reception unit 17 outputs information indicating the detection to a user, and receives a user input indicating whether an output content is correct.

### —Detection of Predetermined Behavior of Driver—

Detection of predetermined behavior of a driver being performed for processing of the correct/incorrect input reception unit 17 may be achieved by a third detection unit 14. In addition, detection of predetermined behavior of a driver being performed for the processing of the correct/incorrect input reception unit 17 may be achieved by a means different from the third detection unit 14.

As an example of the means different from the third detection unit 14, an example of detecting predetermined behavior of a driver, based on data generated by a sensor installed on a moving body without using a detection result of a predetermined pose and the like and a detection result of a predetermined object is conceivable. In the example, for example, data of a sensor that detects a holding state of a handle, a sensor that detects a steering angle of a handle, a sensor that detects a brake operation by a driver, and the like can be used.

When a driver performs predetermined behavior as described above, a state of a handle may not be stable and a steering angle of the handle may gradually change. Further, when a driver performs predetermined behavior described above, attentiveness of the driver to the surroundings becomes sluggish, and thus brakes may be frequently applied. The correct/incorrect input reception unit 17 may detect predetermined behavior of a driver by detecting feature data that appear in response to such a phenomenon from among pieces of data of a sensor.

Note that, a phenomenon such as a “state of a handle is not stable and a steering angle of the handle gradually changes” and “brakes are frequently applied” may also appear when a driver does not perform predetermined behavior. For example, when a driving skill, a state of tension, a health state, and the like of a driver satisfy a predetermined condition, such a phenomenon may appear.

Thus, the correct/incorrect input reception unit 17 may detect behavior as predetermined behavior of a driver when the correct/incorrect input reception unit 17 detects feature data that appear in response to the phenomenon as described above from among pieces of data of a sensor and the data of the sensor that detects a holding state of a handle indicate that both hands do not hold the handle.

When a handle is held with both hands, there is a low possibility that predetermined behavior such as a “call using a cellular phone”, an “operation on a cellular phone”, an “act of reading a magazine, a book, a newspaper, and the like”, an “act of eating”, an “act of drinking”, an “act of taking out a cigarette from a case”, and an “act of lighting a cigarette” is performed. With a configuration in which predetermined behavior of a driver is detected when a condition that a “handle is not held with both hands” is satisfied, an inconvenience that the predetermined behavior is detected by mistake when a driver does not perform the predetermined behavior can be reduced.

### —Output to User and Reception of Input—

When predetermined behavior of a driver is detected, the correct/incorrect input reception unit 17 can output information indicating the detection to a user via various output apparatuses. As the output apparatus, a display, a speaker, a projection apparatus, and the like are exemplified, which are not limited thereto.

The correct/incorrect input reception unit 17 may output the information described above at a timing of detection of predetermined behavior of a driver in response to the detection. In addition, the correct/incorrect input reception unit 17 may output the information described above at a timing at which a movement of a moving body is first stopped after predetermined behavior of a driver is detected.

The information to be output indicates a content of detected predetermined behavior, and also includes a request to input whether a detection result of the predetermined behavior is correct. When the information described above is output at a timing at which a movement of a moving body is first stopped after predetermined behavior of a driver is detected, the information to be output preferably further includes information (for example: five minutes ago, 13:15, and the like) indicating a timing at which the predetermined behavior of the driver is detected. As an example of the information to be output, “A call using a cellular phone during driving was detected. Is the detection result correct? Yes or No”, “A call using a cellular phone during driving was detected five minutes ago. Is the detection result correct? Yes or No”, and the like are conceivable, which are not limited thereto.

The correct/incorrect input reception unit 17 performs the output as described above, and then receives a user input indicating whether an output content (detection result) is correct via various input apparatuses. As the input apparatuses, a touch panel, a microphone, a physical button, a camera involving a gesture input, and the like are exemplified, which are not limited thereto.

When the correct/incorrect input reception unit 17 receives a user input indicating that an output content is correct, the transmission unit 18 transmits, as an image indicating the predetermined behavior, an image used for detection of the predetermined behavior to the server 20. A transmission means is not particularly limited, and every technique can be used.

The server 20 newly generates reference data, based on the received image indicating the predetermined behavior being preset, and newly registers the reference data in a reference data DB 21.

Another configuration of the driver surveillance apparatus 10 according to the present example embodiment is similar to that in the first to fourth example embodiments.

As described above, the driver surveillance apparatus 10 according to the present example embodiment can achieve an advantageous effect similar to that in the first to fourth example embodiments. Further, the driver surveillance apparatus 10 according to the present example embodiment can transmit an image indicating predetermined behavior actually performed by a driver to the server 20. Then, the server 20 can process the received image, and update reference data.

As a result, the reference data can be improved with a lapse of time, and detection accuracy accordingly improves.

### Sixth Example Embodiment

In the present example embodiment, processing of analyzing an image and detecting a predetermined pose and the like is embodied.

### “Consideration for Present Example Embodiment”

In recent years, an image recognition technique using machine learning such as deep learning is applied to various systems. For example, application to a surveillance system for performing surveillance by an image of a surveillance camera has been advanced. By using machine learning in the surveillance system, a state such as a pose and a movement of a person is being recognizable from an image to some extent.

However, in such a related technique, a state of a person desired by a user may not be necessarily recognizable on demand. For example, there is a case where a state of a person desired to be searched and recognized by a user can be determined in advance, or there is a case where a determination cannot be specifically made as in an unknown state. Thus, in some cases, a state of a person desired to be searched by a user cannot be specifically specified. Further, a search or the like cannot be performed when a part of a body of a person is hidden. In the related technique, a state of a person can be searched only from a specific search condition, and thus it is difficult to flexibly search for and classify a desired state of a person.

Thus, in the present example embodiment, a skeleton estimation technique such as Non-Patent Document 1 is used in order to recognize a state of a person desired by a user from an image on demand. Similarly to OpenPose disclosed in Non-Patent Document 1, and the like, in the related skeleton estimation technique, a skeleton of a person is estimated by learning image data in which various correct answer patterns are set. In the following example embodiments, a state of a person can be flexibly recognized by using such a skeleton estimation technique.

Note that, a skeleton structure estimated by the skeleton estimation technique such as OpenPose is formed of a “keypoint” being a characteristic point such as a joint and a “bone (bone link)” indicating a link between keypoints. Thus, in the following example embodiments, a skeleton structure will be described by using the words “keypoint” and “bone”, and “keypoint” is associated with a “joint” of a person and “bone” is associated with a “bone” of a person unless otherwise specified.

### “Outline”

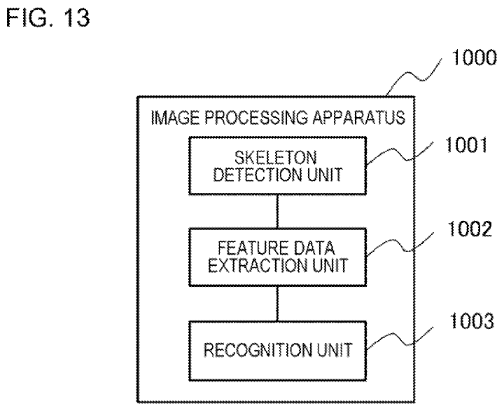

FIG. 13 illustrates an outline of an image processing apparatus 1000 according to an example embodiment. As illustrated in FIG. 13, the image processing apparatus 1000 includes a skeleton detection unit 1001, a feature data extraction unit 1002, and a recognition unit 1003. The skeleton detection unit 1001 detects two-dimensional skeleton structures of a plurality of persons, based on a two-dimensional image acquired from a camera and the like. The feature data extraction unit 1002 extracts feature data about the plurality of two-dimensional skeleton structures detected by the skeleton detection unit 1001. The recognition unit 1003 performs recognition processing on a state of the plurality of persons, based on a degree of similarity between the plurality of pieces of feature data extracted by the feature data extraction unit 1002. The recognition processing is classification processing, search processing, and the like of a state of a person.

In this way, in the present example embodiment, a two-dimensional skeleton structure of a person is detected from a two-dimensional image, and the recognition processing such as classification and a search of a state of a person is performed based on feature data extracted from the two-dimensional skeleton structure, and thus a desired state of a person can be flexibly recognized.

Then, in the present example embodiment, the first detection unit 12 of the driver surveillance apparatus 10 is achieved by using such an image processing apparatus 1000.

### “Functional Configuration”

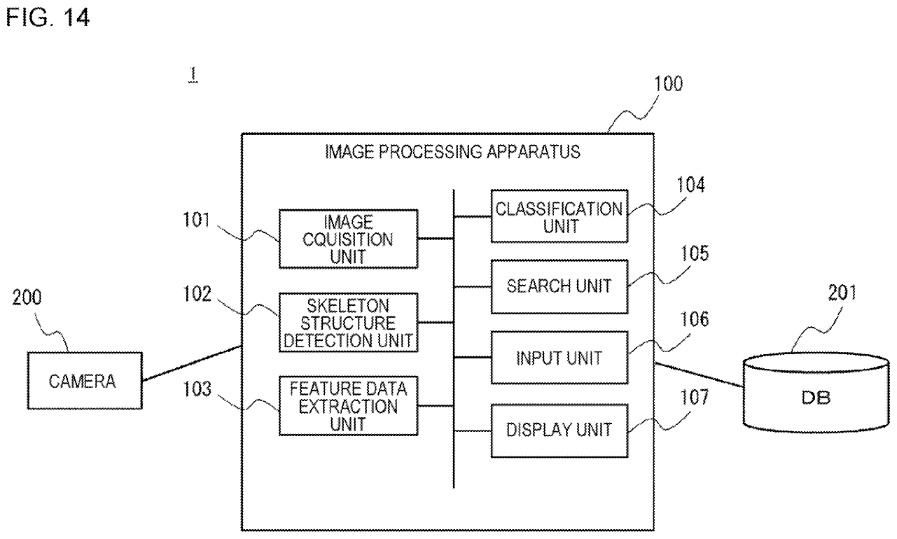

Hereinafter, a functional configuration of the present example embodiment will be described in detail with reference to the drawings. FIG. 14 illustrates a configuration of an image processing apparatus 100 according to the present example embodiment. The image processing apparatus 100 is acquired by further embodying the functional configuration of the image processing apparatus 1000 described above. The image processing apparatus 100 constitutes an image processing system 1 together with a camera 200 and a database (DB) 201. An image processing system 1 including the image processing apparatus 100 is a system for classifying and searching for a state such as a pose and a movement of a person, based on a skeleton structure of the person estimated from an image.

The camera 200 is a capturing unit, such as a surveillance camera, that generates a two-dimensional image. The camera 200 is installed at a predetermined place, and captures a person and the like in a capturing region from the installed place. In the present example embodiment, the camera 200 is installed in a moving body in a position and an orientation in which a driver can be captured. It is assumed that the camera 200 is directly connected in such a way as to be able to output a captured image (video) to the image processing apparatus 100, or is connected via a network and the like. Note that, the camera 200 may be provided inside the image processing apparatus 100.

The database 201 is a database that stores information (data) needed for processing of the image processing apparatus 100, a processing result, and the like. The database 201 stores an image acquired by an image acquisition unit 101, a detection result of a skeleton structure detection unit 102, data for machine learning, feature data extracted by a feature data extraction unit 103, a classification result of a classification unit 104, a search result of a search unit 105, and the like. The database 201 is directly connected to the image processing apparatus 100 in such a way as to be able to input and output data as necessary, or is connected to the image processing apparatus 100 via a network and the like. Note that, the database 201 may be provided inside the image processing apparatus 100 as a non-volatile memory such as a flash memory, a hard disk apparatus, and the like.

As illustrated in FIG. 14, the image processing apparatus 100 includes the image acquisition unit 101, the skeleton structure detection unit 102, the feature data extraction unit 103, the classification unit 104, the search unit 105, an input unit 106, and a display unit 107. Note that, a configuration of each unit (block) is one example, and other each unit may be used for a configuration as long as a method (operation) described below can be achieved. Further, the image processing apparatus 100 is achieved by a computer apparatus, such as a personal computer and a server, that executes a program, for example, but may be achieved by one apparatus or may be achieved by a plurality of apparatuses on a network. For example, the input unit 106, the display unit 107, and the like may be an external apparatus. Further, both of the classification unit 104 and the search unit 105 may be provided, or only one of them may be provided. Both or one of the classification unit 104 and the search unit 105 is a recognition unit that performs the recognition processing on a state of a person.

The image acquisition unit 101 acquires a two-dimensional image including a person captured by the camera 200. The image acquisition unit 101 acquires an image (video including a plurality of images) including a person captured by the camera 200 in a predetermined surveillance period, for example.

The skeleton structure detection unit 102 detects a two-dimensional skeleton structure of a person in the image, based on the acquired two-dimensional image. The skeleton structure detection unit 102 detects a skeleton structure for a person detected in a region in the image in which a driver is located. The skeleton structure detection unit 102 detects a skeleton structure of a person, based on a feature to be recognized such as a joint of the person, by using a skeleton estimation technique using machine learning. The skeleton structure detection unit 102 uses a skeleton estimation technique such as OpenPose in Non-Patent Document 1, for example.

The feature data extraction unit 103 extracts feature data about the detected two-dimensional skeleton structure, and stores, in the database 201, the extracted feature data in association with the image being a processing target. The feature data about the skeleton structure indicate a feature of a skeleton of the person, and are an element for classifying and searching for a state of the person, based on the skeleton of the person. The feature data normally include a plurality of parameters (for example, a classification element described below). Then, the feature data may be feature data about the entire skeleton structure, may be feature data about a part of the skeleton structure, or may include a plurality of pieces of feature data as in each portion of the skeleton structure. A method for extracting feature data may be any method such as machine learning and normalization, and a minimum value and a maximum value may be acquired as normalization. As one example, the feature data are feature data acquired by performing machine learning on the skeleton structure, a size of the skeleton structure from a head to a foot on an image, and the like. The size of the skeleton structure is a height in the up-down direction, an area, and the like of a skeleton region including the skeleton structure on an image. The up-down direction (a height direction or a vertical direction) is a direction (Y-axis direction) of up and down in an image, and is, for example, a direction perpendicular to the ground (reference surface). Further, the left-right direction (a horizontal direction) is a direction (X-axis direction) of left and right in an image, and is, for example, a direction parallel to the ground.

Note that, in order to perform classification and a search desired by a user, feature data having robustness with respect to classification and search processing are preferably used. For example, when a user desires classification and a search that do not depend on an orientation and a body shape of a person, feature data that are robust with respect to the orientation and the body shape of the person may be used. Feature data that do not depend on an orientation and a body shape of a person can be acquired by learning skeletons of persons facing in various directions with the same pose and skeletons of persons having various body shapes with the same pose, and extracting a feature only in the up-down direction of a skeleton.

The classification unit 104 classifies a plurality of skeleton structures stored in the database 201, based on a degree of similarity between pieces of feature data about the skeleton structures (performs clustering). It can also be said that, as the recognition processing on a state of a person, the classification unit 104 classifies states of a plurality of persons, based on feature data about the skeleton structures. A degree of similarity is a distance between pieces of feature data about skeleton structures. The classification unit 104 may perform classification by a degree of similarity between pieces of feature data about the entire skeleton structures, may perform classification by a degree of similarity between pieces of feature data about a part of the skeleton structures, and may perform classification by a degree of similarity between pieces of feature data about a first portion (for example, both hands) and a second portion (for example, both feet) of the skeleton structures. Note that, a pose of a person may be classified based on feature data about a skeleton structure of the person in each image, and a movement of a person may be classified based on a change in feature data about a skeleton structure of the person in a plurality of images successive in time series. In other words, the classification unit 104 can classify a state of a person including a pose and a movement of the person, based on feature data about a skeleton structure. For example, the classification unit 104 sets, as classification targets, a plurality of skeleton structures in a plurality of images captured in a predetermined surveillance period. The classification unit 104 acquires a degree of similarity between pieces of feature data about classification targets, and performs classification in such a way that skeleton structures having a high degree of similarity are in the same cluster (group with a similar pose). Note that, similarly to a search, a user may be able to specify a classification condition. The classification unit 104 stores a classification result of the skeleton structure in the database 201.

The search unit 105 searches for a skeleton structure having a high degree of similarity to feature data being a search query (query state) from among the plurality of skeleton structures stored in the database 201. In the present example embodiment, feature data indicating a pose and the like of a driver extracted from an image in which the driver is captured are a search query.

It can also be said that, as the recognition processing on a state of a person, the search unit 105 searches for a state of a person that corresponds to a search condition (query state) from among states of a plurality of persons, based on feature data about the skeleton structures. Similarly to classification, the degree of similarity is a distance between the pieces of feature data about the skeleton structures. The search unit 105 may perform a search by a degree of similarity between pieces of feature data about the entire skeleton structures, may perform a search by a degree of similarity between pieces of feature data about a part of the skeleton structures, and may perform a search by a degree of similarity between pieces of feature data about a first portion (for example, both hands) and a second portion (for example, both feet) of the skeleton structures. Note that, a pose of a person may be searched based on feature data about a skeleton structure of the person in each image, and a movement of a person may be searched based on a change in feature data about a skeleton structure of the person in a plurality of images successive in time series. In other words, the search unit 105 can search for a state of a person including a pose and a movement of the person, based on feature data about a skeleton structure. For example, similarly to classification targets, the search unit 105 sets, as search targets, feature data about a plurality of skeleton structures in a plurality of images captured in a predetermined surveillance period. Note that, regardless of a classification result, a search query may be selected from among a plurality of skeleton structures that are not classified, or a user may input a skeleton structure to be a search query. The search unit 105 searches for feature data having a high degree of similarity to feature data about a skeleton structure being a search query from among pieces of feature data being search targets.

The input unit 106 is an input interface that acquires information input from a user who operates the image processing apparatus 100. For example, a user is a driver of a moving body. The input unit 106 is, for example, a graphical user interface (GUI), and receives an input of information according to an operation of the user from an input apparatus such as a keyboard, a mouse, a touch panel, and a microphone.

The display unit 107 is a display unit that displays a result of an operation (processing) of the image processing apparatus 100, and the like, and is, for example, a display apparatus such as a liquid crystal display and an organic electro luminescence (EL) display.

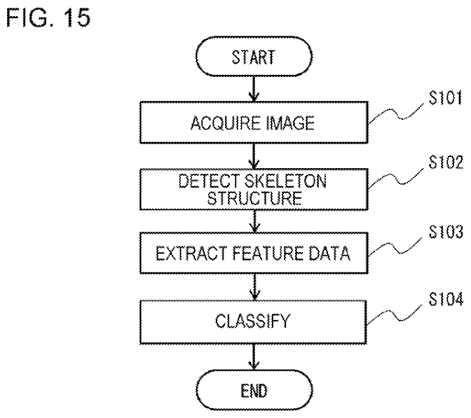

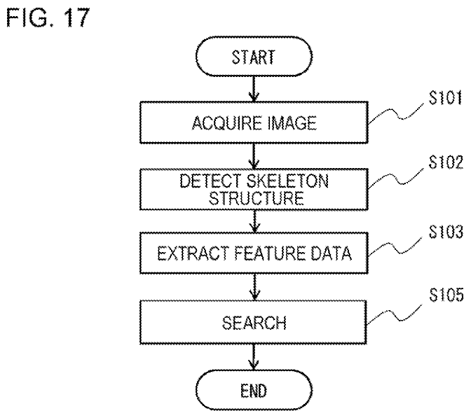

FIGS. 15 to 17 illustrate operations of the image processing apparatus 100 according to the present example embodiment. FIG. 15 illustrates a flow of processing when the image processing apparatus 100 is applied to the server 20 in FIG. 10, and FIG. 17 illustrates a flow of processing when the image processing apparatus 100 is applied to the driver surveillance apparatus 10 in FIG. 10.

First, the flow of the processing when the image processing apparatus 100 is applied to the server 20 in FIG. 10 will be described. As illustrated in FIG. 15, the image processing apparatus 100 acquires an image data set (S101). The image acquisition unit 101 acquires an image in which a person is captured for performing classification from a skeleton structure, and stores the acquired image in the database 201.

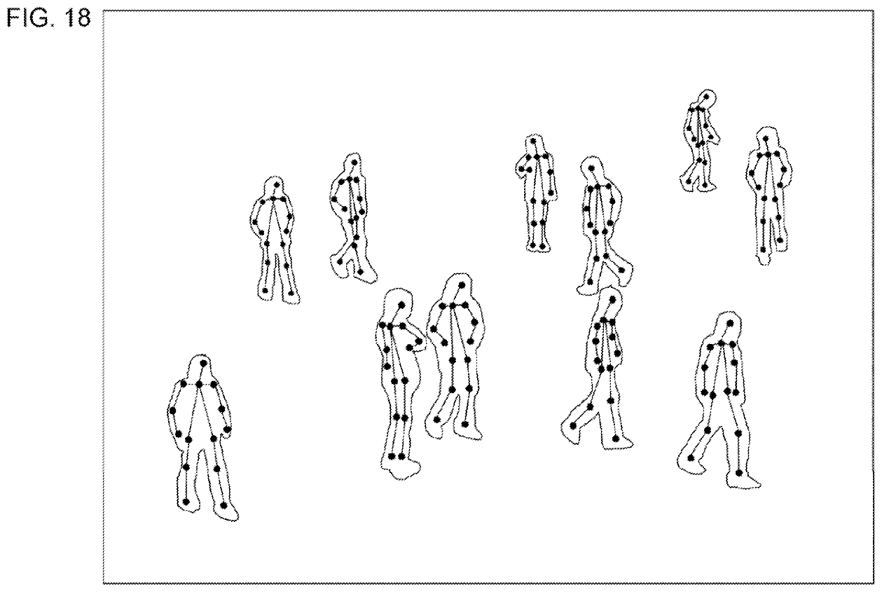

Subsequently, the image processing apparatus 100 detects a skeleton structure of a person, based on the acquired image of the person (S102). FIG. 18 illustrates a detection example of skeleton structures. As illustrated in FIG. 18, a plurality of persons are included in an image acquired from a surveillance camera or the like, and a skeleton structure is detected for each of the persons included in the image.

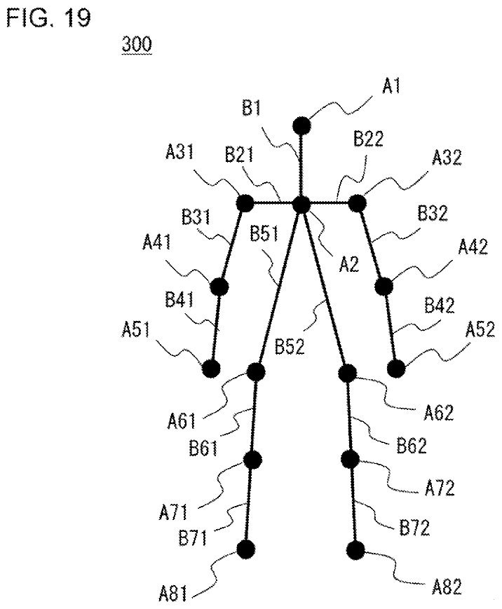

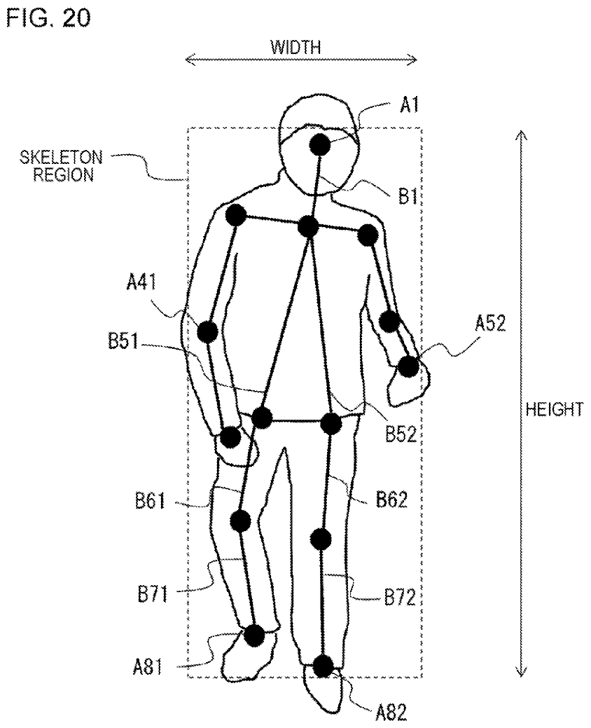

FIG. 19 illustrates a skeleton structure of a human model 300 detected at this time, and FIGS. 20 to 22 each illustrate a detection example of the skeleton structure. The skeleton structure detection unit 102 detects the skeleton structure of the human model (two-dimensional skeleton model) 300 as in FIG. 19 from a two-dimensional image by using a skeleton estimation technique such as OpenPose. The human model 300 is a two-dimensional model formed of a keypoint such as a joint of a person and a bone connecting keypoints.

For example, the skeleton structure detection unit 102 extracts a feature point that may be a keypoint from an image, refers to information acquired by performing machine learning on the image of the keypoint, and detects each keypoint of a person. In the example illustrated in FIG. 19, as a keypoint of a person, a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 are detected. Furthermore, as a bone of the person connecting the keypoints, a bone B1 connecting the head A1 and the neck A2, a bone B21 connecting the neck A2 and the right shoulder A31, a bone B22 connecting the neck A2 and the left shoulder A32, a bone B31 connecting the right shoulder A31 and the right elbow A41, a bone B32 connecting the left shoulder A32 and the left elbow A42, a bone B41 connecting the right elbow A41 and the right hand A51, a bone B42 connecting the left elbow A42 and the left hand A52, a bone B51 connecting the neck A2 and the right waist A61, a bone B52 connecting the neck A2 and the left waist A62, a bone B61 connecting the right waist A61 and the right knee A71, a bone B62 connecting the left waist A62 and the left knee A72, a bone B71 connecting the right knee A71 and the right foot A81, and a bone B72 connecting the left knee A72 and the left foot A82 are detected. The skeleton structure detection unit 102 stores the detected skeleton structure of the person in the database 201.

FIG. 20 is an example of detecting a person in an upright state. In FIG. 20, the upright person is captured from the front, the bone B1, the bone B51 and the bone B52, the bone B61 and the bone B62, and the bone B71 and the bone B72 that are viewed from the front are each detected without overlapping, and the bone B61 and the bone B71 of a right leg are bent slightly more than the bone B62 and the bone B72 of a left leg.

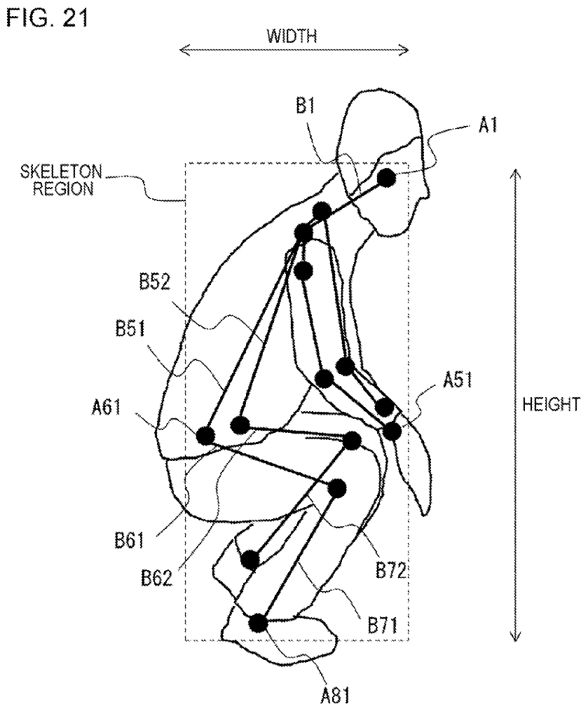

FIG. 21 is an example of detecting a person in a squatting state (sitting state). In FIG. 21, the squatting person is captured from a right side, the bone B1, the bone B51 and the bone B52, the bone B61 and the bone B62, and the bone B71 and the bone B72 that are viewed from the right side are each detected, and the bone B61 and the bone B71 of a right leg and the bone B62 and the bone B72 of a left leg are greatly bent and also overlap.

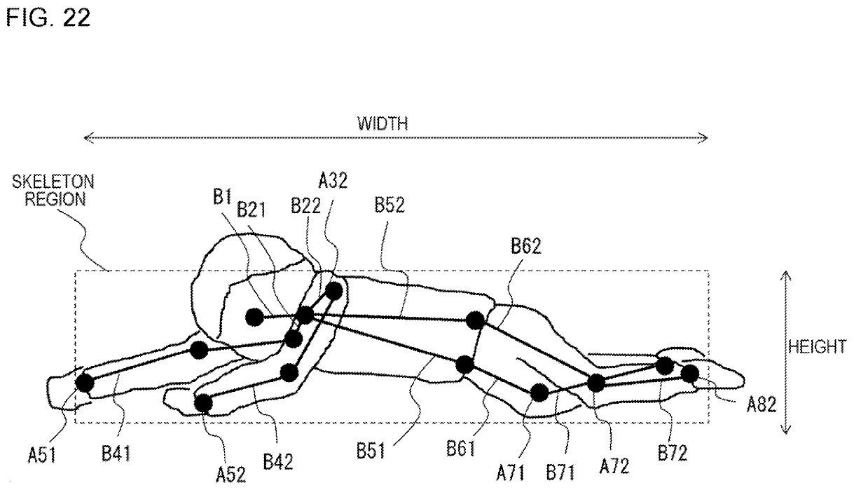

FIG. 22 is an example of detecting a person in a sleeping state. In FIG. 22, the sleeping person is captured diagonally from the front left, the bone B1, the bone B51 and the bone B52, the bone B61 and the bone B62, and the bone B71 and the bone B72 that are viewed diagonally from the front left are each detected, and the bone B61 and the bone B71 of a right leg and the bone B62 and the bone B72 of a left leg are bent and also overlap.

Subsequently, as illustrated in FIG. 15, the image processing apparatus 100 extracts feature data about the detected skeleton structure (S103). For example, when a height and an area of a skeleton region are set as feature data, the feature data extraction unit 103 extracts a region including the skeleton structure and acquires a height (pixel number) and an area (pixel area) of the region. The height and the area of the skeleton region are acquired from coordinates of an end portion of the extracted skeleton region and coordinates of a keypoint of the end portion. The feature data extraction unit 103 stores the acquired feature data about the skeleton structure in the database 201.

In the example in FIG. 20, a skeleton region including all of the bones is extracted from the skeleton structure of the upright person. In this case, an upper end of the skeleton region is the keypoint A1 of the head, a lower end of the skeleton region is the keypoint A82 of the left foot, a left end of the skeleton region is the keypoint A41 of the right elbow, and a right end of the skeleton region is the keypoint A52 of the left hand. Thus, a height of the skeleton region is acquired from a difference in Y coordinate between the keypoint A1 and the keypoint A82. Further, a width of the skeleton region is acquired from a difference in X coordinate between the keypoint A41 and the keypoint A52, and an area is acquired from the height and the width of the skeleton region.

In the example in FIG. 21, a skeleton region including all of the bones is extracted from the skeleton structure of the squatting person. In this case, an upper end of the skeleton region is the keypoint A1 of the head, a lower end of the skeleton region is the keypoint A81 of the right foot, a left end of the skeleton region is the keypoint A61 of the right waist, and a right end of the skeleton region is the keypoint A51 of the right hand. Thus, a height of the skeleton region is acquired from a difference in Y coordinate between the keypoint A1 and the keypoint A81. Further, a width of the skeleton region is acquired from a difference in X coordinate between the keypoint A61 and the keypoint A51, and an area is acquired from the height and the width of the skeleton region.

In the example in FIG. 22, a skeleton region including all of the bones is extracted from the skeleton structure of the sleeping person in the left-right direction of the image. In this case, an upper end of the skeleton region is the keypoint A32 of the left shoulder, a lower end of the skeleton region is the keypoint A52 of the left hand, a left end of the skeleton region is the keypoint A51 of the right hand, and a right end of the skeleton region is the keypoint A82 of the left foot. Thus, a height of the skeleton region is acquired from a difference in Y coordinate between the keypoint A32 and the keypoint A52. Further, a width of the skeleton region is acquired from a difference in X coordinate between the keypoint A51 and the keypoint A82, and an area is acquired from the height and the width of the skeleton region.

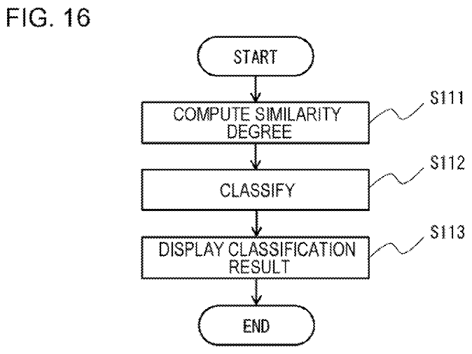

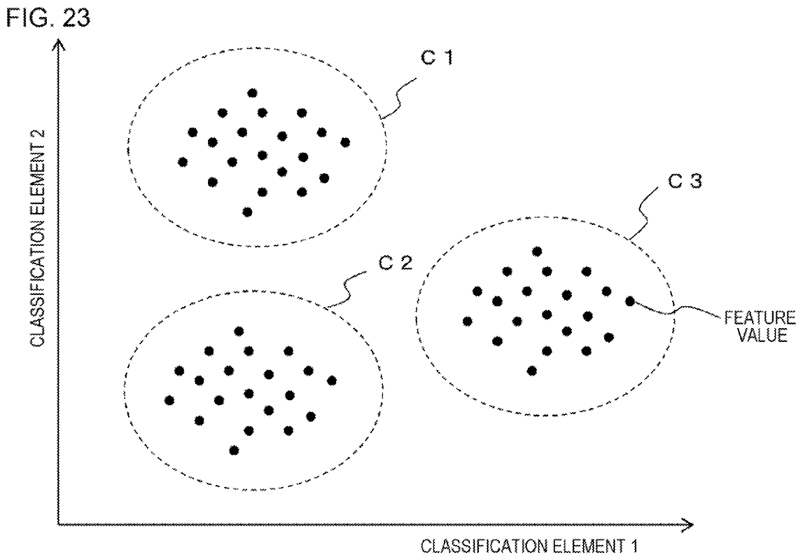

Subsequently, as illustrated in FIG. 15, the image processing apparatus 100 performs classification processing (S104). In the classification processing, as illustrated in FIG. 16, the classification unit 104 computes a degree of similarity of the extracted feature data about the skeleton structure (S111), and classifies the skeleton structure, based on the extracted feature data (S112). The classification unit 104 acquires a degree of similarity of the feature data among all of the skeleton structures that are classification targets and are stored in the database 201, and classifies skeleton structures (poses) having a highest degree of similarity in the same cluster (performs clustering). Furthermore, classification is performed by acquiring a degree of similarity between classified clusters, and classification is repeated until a predetermined number of clusters is acquired. FIG. 23 illustrates an image of a classification result of feature data about skeleton structures. FIG. 23 is an image of a cluster analysis by two-dimensional classification elements, and two classification elements are, for example, a height of a skeleton region and an area of the skeleton region, or the like. In FIG. 23, as a result of classification, feature data about a plurality of skeleton structures are classified into three clusters C1 to C3. The clusters C1 to C3 are associated with poses such as a standing pose, a sitting pose, and a sleeping pose, for example, and skeleton structures (persons) are classified for each similar pose.

In the present example embodiment, various classification methods can be used by performing classification, based on feature data about a skeleton structure of a person. Note that, a classification method may be preset, or any classification method may be able to be set by a user. Further, classification may be performed by the same method as a search method described below. In other words, classification may be performed by a classification condition similar to a search condition. For example, the classification unit 104 performs classification by the following classification methods. Any classification method may be used, or any selected classification method may be combined. By adopting an appropriate classification method, a cluster associated with each of various predetermined poses can be generated.
(Classification Method 1)

Classification by a plurality of hierarchies Classification is performed by combining, in a hierarchical manner, classification by a skeleton structure of a whole body, classification by a skeleton structure of an upper body and a lower body, classification by a skeleton structure of an arm and a leg, and the like. In other words, classification may be performed based on feature data about a first portion and a second portion of a skeleton structure, and, furthermore, classification may be performed by assigning weights to the feature data about the first portion and the second portion.
(Classification Method 2)

Classification by a plurality of images along time series Classification is performed based on feature data about a skeleton structure in a plurality of images successive in time series. For example, classification may be performed based on a cumulative value by accumulating feature data in a time series direction. Furthermore, classification may be performed based on a change (change value) in feature data about a skeleton structure in a plurality of successive images.
(Classification Method 3)

Classification by ignoring the left and the right of a skeleton structure Classification is performed on an assumption that reverse skeleton structures on a right side and a left side of a person are the same skeleton structure.

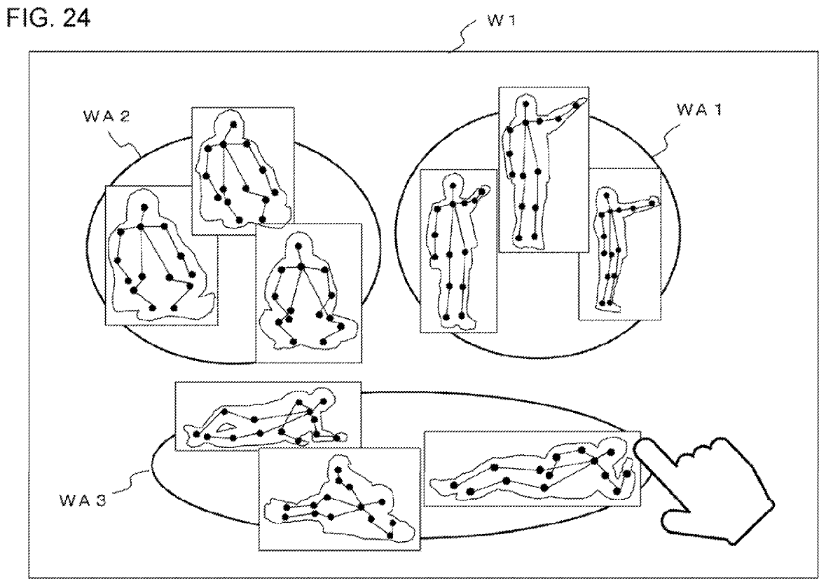

Furthermore, the classification unit 104 displays a classification result of the skeleton structure (S113). The classification unit 104 acquires a necessary image of a skeleton structure and a person from the database 201, and displays, on the display unit 107, the skeleton structure and the person for each similar pose (cluster) as a classification result. FIG. 24 illustrates a display example when poses are classified into three. For example, as illustrated in FIG. 24, pose regions WA1 to WA3 for each pose are displayed on a display window W1, and a skeleton structure and a person (image) of each associated pose are displayed in the pose regions WA1 to WA3. The pose region WA1 is, for example, a display region of a standing pose, and displays a skeleton structure and a person that are classified into the cluster C1 and are similar to the standing pose. The pose region WA2 is, for example, a display region of a sitting pose, and displays a skeleton structure and a person that are classified into the cluster C2 and are similar to the sitting pose. The pose region WA3 is, for example, a display region of a sleeping pose, and displays a skeleton structure and a person that are classified into the cluster C2 and are similar to the sleeping pose.

Next, the flow of the processing when the image processing apparatus 100 is applied to the driver surveillance apparatus 10 in FIG. 10 will be described. As illustrated in FIG. 17, the image processing apparatus 100 acquires an image (image in which a driver is captured) from the camera 200 (camera 30) (S101). The image acquisition unit 101 acquires the image.

Subsequently, the image processing apparatus 100 detects a skeleton structure of a person, based on the acquired image of the person (S102). Next, the image processing apparatus 100 extracts feature data about the detected skeleton structure (S103). S102 and S103 are similar to the processing described by using FIG. 15.

Next, the image processing apparatus 100 searches the database 201 (storage unit 15) with the feature data extracted in S103 as a search query, and determines at least one of a pose and a movement indicated by the feature data extracted in S103. Specifically, the search unit 105 searches for feature data whose degree of similarity to the feature data being the search query is equal to or more than a threshold value from among all pieces of feature data stored in the database 201. Then, the search unit 105 determines at least one of a pose and a movement associated with the searched feature data.

In the present example embodiment, similarly to the classification methods, various search methods can be used by performing a search, based on feature data about a skeleton structure of a person. Note that, a search method may be preset, or any search method may be able to be set by a user. For example, the search unit 105 performs a search by the following search methods. Any search method may be used, or any selected search method may be combined. A search may be performed by combining a plurality of search methods (search conditions) by a logical expression (for example, AND (conjunction), OR (disjunction), NOT (negation)). For example, a search may be performed by setting “(pose with a right hand up) AND (pose with a left foot up)” as a search condition.
(Search Method 1)

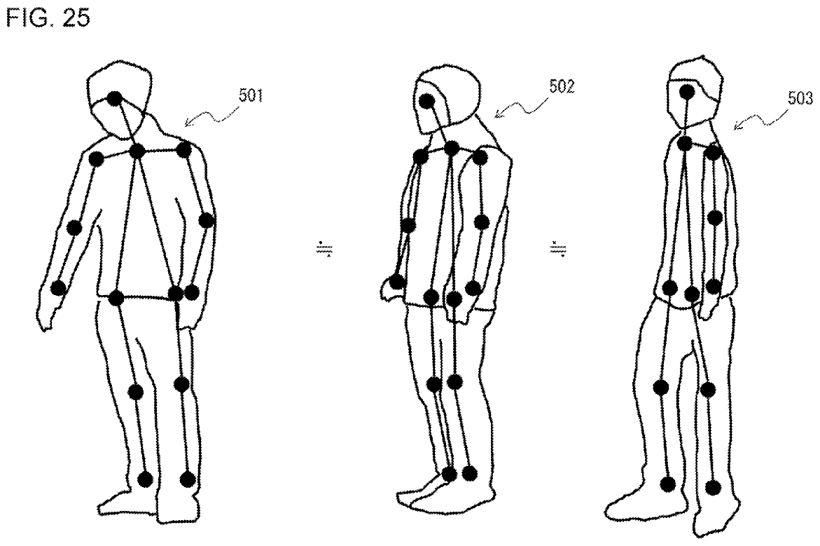

A search only by feature data in the height direction By performing a search by using only feature data in the height direction of a person, an influence of a change in the horizontal direction of a person can be suppressed, and robustness improves with respect to a change in orientation of the person and body shape of the person. For example, as in skeleton structures 501 to 503 in FIG. 25, even when an orientation and a body shape of a person are different, feature data in the height direction do not greatly change. Thus, in the skeleton structures 501 to 503, it can be decided that poses are the same at a time of a search (at a time of classification).
(Search Method 2)

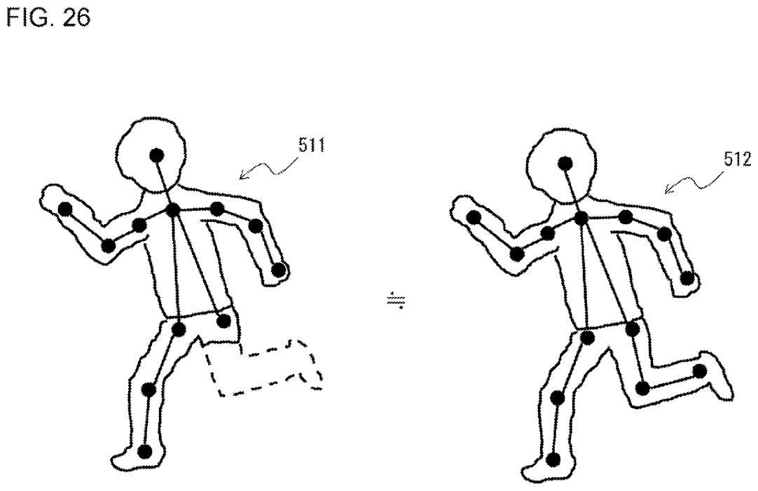

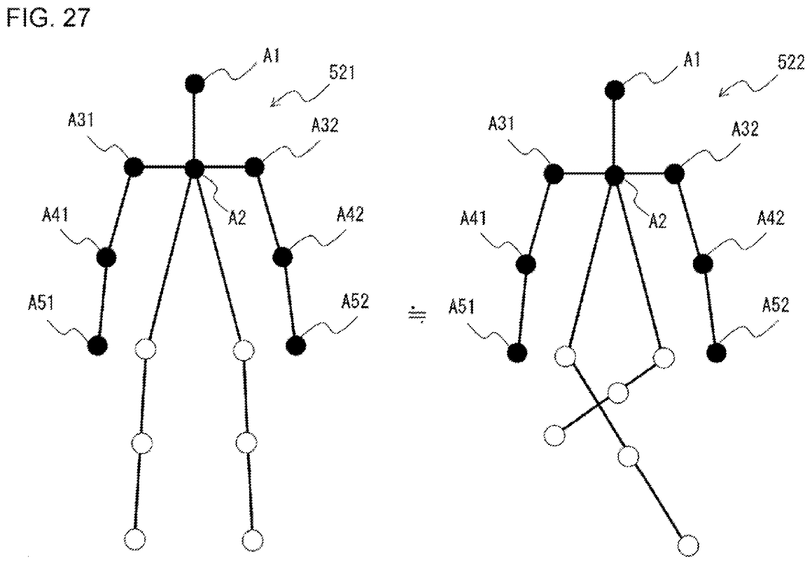

When a part of a body of a person is hidden in a partial search image, a search is performed by using only information about a recognizable portion. For example, as in skeleton structures 511 and 512 in FIG. 26, even when a keypoint of a left foot cannot be detected due to the left foot being hidden, a search can be performed by using feature data about another detected keypoint. Thus, in the skeleton structures 511 and 512, it can be decided that poses are the same at a time of a search (at a time of classification). In other words, classification and a search can be performed by using feature data about some of keypoints instead of all keypoints. In an example of skeleton structures 521 and 522 in FIG. 27, although orientations of both feet are different, it can be decided that poses are the same by setting feature data about keypoints (A1, A2, A31, A32, A41, A42, A51, and A52) of an upper body as a search query. Further, a search may be performed by assigning a weight to a portion (feature point) desired to be searched, or a threshold value of a similarity degree determination may be changed. When a part of a body is hidden, a search may be performed by ignoring the hidden portion, or a search may be performed by taking the hidden portion into consideration. By performing a search also including a hidden portion, a pose in which the same portion is hidden can be searched.
(Search Method 3)

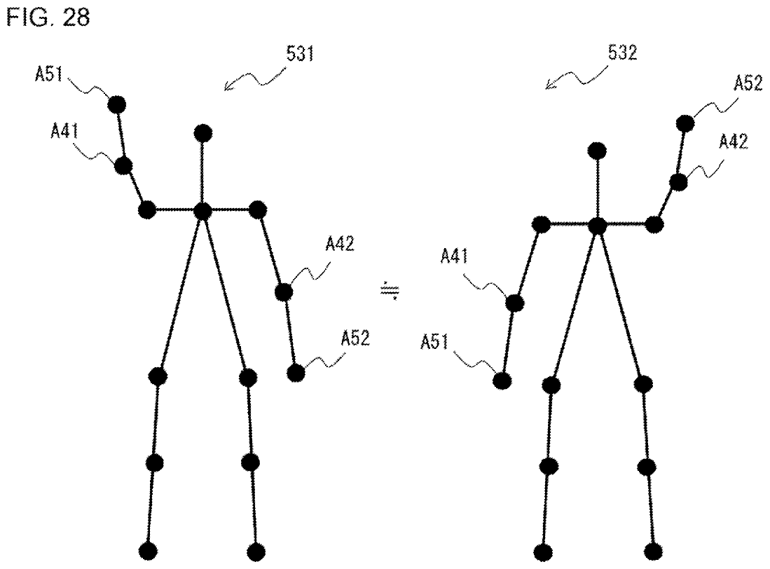

A search by ignoring the left and the right of a skeleton structure A search is performed on an assumption that reverse skeleton structures on a right side and a left side of a person are the same skeleton structure. For example, as in skeleton structures 531 and 532 in FIG. 28, a pose with a right hand up and a pose with a left hand up can be searched (classified) as the same pose. In the example in FIG. 28, in the skeleton structure 531 and the skeleton structure 532, although positions of the keypoint A51 of the right hand, the keypoint A41 of the right elbow, the keypoint A52 of the left hand, and the keypoint A42 of the left elbow are different, positions of the other keypoints are the same. When the keypoints of one of the skeleton structures of the keypoint A51 of the right hand and the keypoint A41 of the right elbow of the skeleton structure 531 and the keypoint A52 of the left hand and the keypoint A42 of the left elbow of the skeleton structure 532 are reversed, the keypoints have the same positions of the keypoints of the other skeleton structure, and, when the keypoints of one of the skeleton structures of the keypoint A52 of the left hand and the keypoint A42 of the left elbow of the skeleton structure 531 and the keypoint A51 of the right hand and the keypoint A41 of the right elbow of the skeleton structure 532 are reversed, the keypoints have the same positions of the keypoints of the other skeleton structure. Thus, it is decided that poses are the same.
(Search Method 4)

A search by feature data in the vertical direction and the horizontal direction

After a search is performed only with feature data about a person in the vertical direction (Y-axis direction), the acquired result is further searched by using feature data about the person in the horizontal direction (X-axis direction).
(Search Method 5)

A search by a plurality of images along time series A search is performed based on feature data about a skeleton structure in a plurality of images successive in time series. For example, a search may be performed based on a cumulative value by accumulating feature data in a time series direction. Furthermore, a search may be performed based on a change (change value) in feature data about a skeleton structure in a plurality of successive images.

As described above, in the present example embodiment, a skeleton structure of a person can be detected from a two-dimensional image, and classification and a search can be performed based on feature data about the detected skeleton structure. In this way, classification can be performed for each similar pose having a high degree of similarity, and a similar pose having a high degree of similarity to a search query (search key) can be searched. By classifying similar poses from an image and displaying the similar poses, a user can recognize a pose of a person in the image without specifying a pose and the like. Since the user can specify a pose being a search query from a classification result, a desired pose can be searched even when a pose desired to be searched by a user is not recognized in detail in advance. For example, since classification and a search can be performed with a whole or a part of a skeleton structure of a person and the like as a condition, flexible classification and a flexible search can be performed.

### Seventh Example Embodiment

Hereinafter, a seventh example embodiment will be described with reference to the drawings. In the present example embodiment, a specific example of the feature data extraction processing in the sixth example embodiment will be described. In the present example embodiment, feature data are acquired by normalization by using a height of a person. The other points are similar to those in the sixth example embodiment.

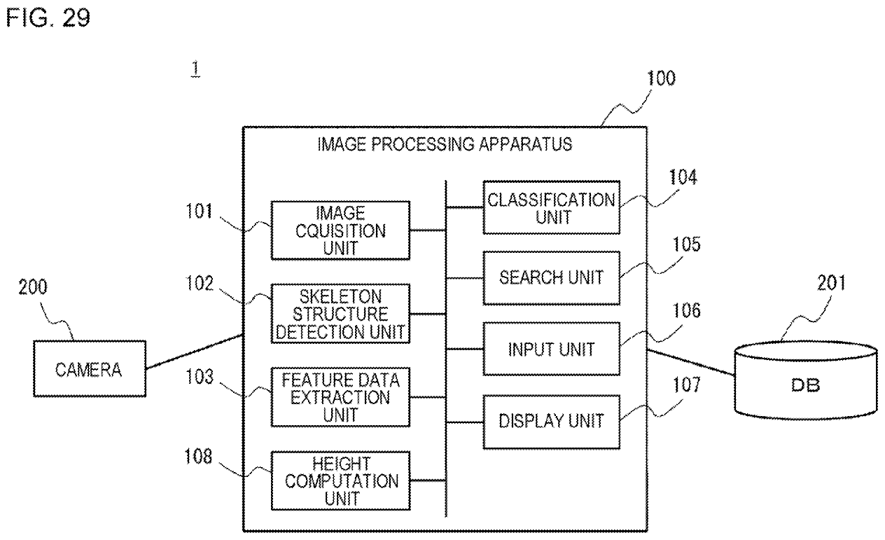

FIG. 29 illustrates a configuration of an image processing apparatus 100 according to the present example embodiment. As illustrated in FIG. 29, the image processing apparatus 100 further includes a height computation unit 108 in addition to the configuration in the sixth example embodiment. Note that, a feature data extraction unit 103 and the height computation unit 108 may serve as one processing unit.

The height computation unit (height estimation unit) 108 computes (estimates) an upright height (referred to as a height pixel number) of a person in a two-dimensional image, based on a two-dimensional skeleton structure detected by a skeleton structure detection unit 102. It can be said that the height pixel number is a height of a person in a two-dimensional image (a length of a whole body of a person on a two-dimensional image space). The height computation unit 108 acquires a height pixel number (pixel number) from a length (length on the two-dimensional image space) of each bone of a detected skeleton structure.

In the following examples, specific examples 1 to 3 are used as a method for acquiring a height pixel number. Note that, any method of the specific examples 1 to 3 may be used, or a plurality of any selected methods may be combined and used. In the specific example 1, a height pixel number is acquired by adding up lengths of bones from a head to a foot among bones of a skeleton structure. When the skeleton structure detection unit 102 (skeleton estimation technique) does not output a top of a head and a foot, a correction can be performed by multiplication by a constant as necessary. In the specific example 2, a height pixel number is computed by using a human model indicating a relationship between a length of each bone and a length of a whole body (a height on the two-dimensional image space). In the specific example 3, a height pixel number is computed by fitting (applying) a three-dimensional human model to a two-dimensional skeleton structure.

The feature data extraction unit 103 according to the present example embodiment is a normalization unit that normalizes a skeleton structure (skeleton information) of a person, based on a computed height pixel number of the person. The feature data extraction unit 103 stores feature data (normalization value) about the normalized skeleton structure in a database 201. The feature data extraction unit 103 normalizes, by the height pixel number, a height on an image of each keypoint (feature point) included in the skeleton structure. In the present example embodiment, for example, a height direction is an up-down direction (Y-axis direction) in a two-dimensional coordinate (X-Y coordinate) space of an image. In this case, a height of a keypoint can be acquired from a value (pixel number) of a Y coordinate of the keypoint. Alternatively, a height direction may be a direction (vertical projection direction) of a vertical projection axis in which a direction of a vertical axis perpendicular to the ground (reference surface) in a three-dimensional coordinate space in a real world is projected in the two-dimensional coordinate space. In this case, a height of a keypoint can be acquired by acquiring a vertical projection axis in which an axis perpendicular to the ground in the real world is projected in the two-dimensional coordinate space, based on a camera parameter, and being acquired from a value (pixel number) along the vertical projection axis. Note that, the camera parameter is a capturing parameter of an image, and, for example, the camera parameter is a pose, a position, a capturing angle, a focal distance, and the like of a camera 200. The camera 200 captures an image of an object whose length and position are clear in advance, and a camera parameter can be acquired from the image. A strain may occur at both ends of the captured image, and the vertical direction in the real world and the up-down direction in the image may not match. In contrast, an extent that the vertical direction in the real world is tilted in an image is clear by using a parameter of a camera that captures the image. Thus, feature data about keypoint can be acquired in consideration of a difference between the real world and the image by normalizing, by a height, a value of the keypoint along a vertical projection axis projected in the image, based on the camera parameter. Note that, a left-right direction (a horizontal direction) is a direction (X-axis direction) of left and right in a two-dimensional coordinate (X-Y coordinate) space of an image, or is a direction in which a direction parallel to the ground in the three-dimensional coordinate space in the real world is projected in the two-dimensional coordinate space.

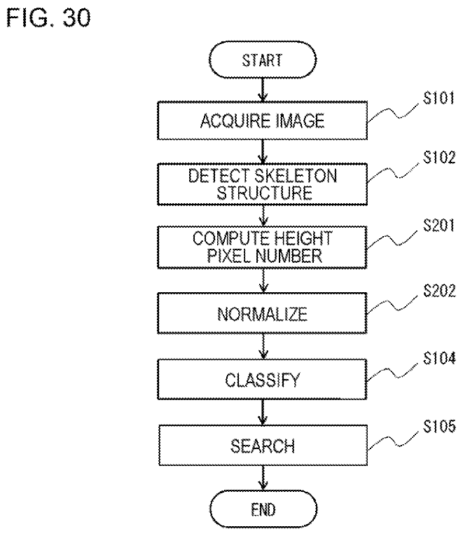

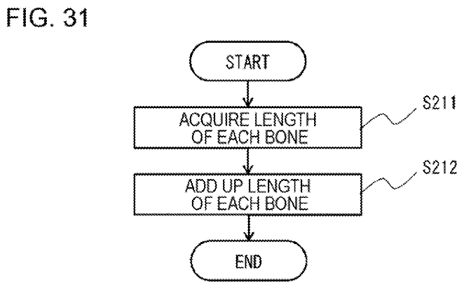

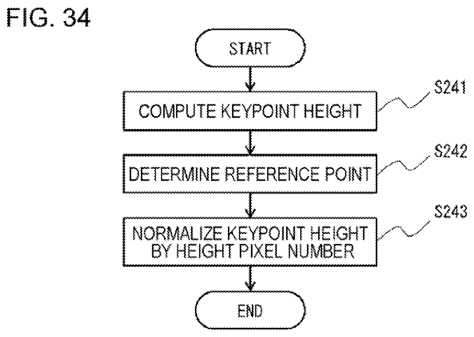

FIGS. 30 to 34 illustrate operations of the image processing apparatus 100 according to the present example embodiment. FIG. 30 illustrates a flow from image acquisition to search processing in the image processing apparatus 100, FIGS. 31 to 33 illustrate flows of specific examples 1 to 3 of height pixel number computation processing (S201) in FIG. 30, and FIG. 34 illustrates a flow of normalization processing (S202) in FIG. 30.

As illustrated in FIG. 30, in the present example embodiment, the height pixel number computation processing (S201) and the normalization processing (S202) are performed as the feature data extraction processing (S103) in the sixth example embodiment. The other points are similar to those in the sixth example embodiment. Note that, the image processing apparatus 100 may perform both or only one of the classification processing (S104) and the search processing (S105) as illustrated in FIG. 30.

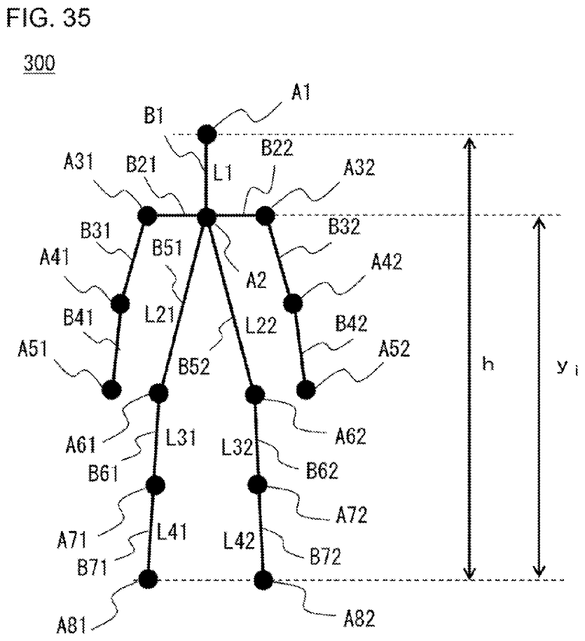

The image processing apparatus 100 performs the height pixel number computation processing (S201), based on a detected skeleton structure, after the image acquisition (S101) and skeleton structure detection (S102). In this example, as illustrated in FIG. 35, a height of a skeleton structure of an upright person in an image is a height pixel number (h), and a height of each keypoint of the skeleton structure in a state of the person in the image is a keypoint height (yi). Hereinafter, the specific examples 1 to 3 of the height pixel number computation processing will be described.

### Specific Example 1

In the specific example 1, a height pixel number is acquired by using a length of a bone from a head to a foot. In the specific example 1, as illustrated in FIG. 31, the height computation unit 108 acquires a length of each bone (S211), and adds up the acquired length of each bone (S212).

The height computation unit 108 acquires a length of a bone from a head to a foot of a person on a two-dimensional image, and acquires a height pixel number. In other words, each length (pixel number) of a bone B1 (length L1), a bone B51 (length L21), a bone B61 (length L31), and a bone B71 (length L41), or the bone B1 (length L1), a bone B52 (length L22), a bone B62 (length L32), and a bone B72 (length L42) among bones in FIG. 35 is acquired from the image in which the skeleton structure is detected. A length of each bone can be acquired from coordinates of each keypoint in the two-dimensional image. A value acquired by multiplying, by a correction constant, L1+L21+L31+L41 or L1+L22+L32+L42 acquired by adding them up is computed as the height pixel number (h). When both values can be computed, a longer value is set as the height pixel number, for example. In other words, each bone has a longest length in an image when being captured from the front, and is displayed to be short when being tilted in a depth direction with respect to a camera. Therefore, it is conceivable that a longer bone has a higher possibility of being captured from the front, and has a value closer to a true value. Thus, a longer value is preferably selected.

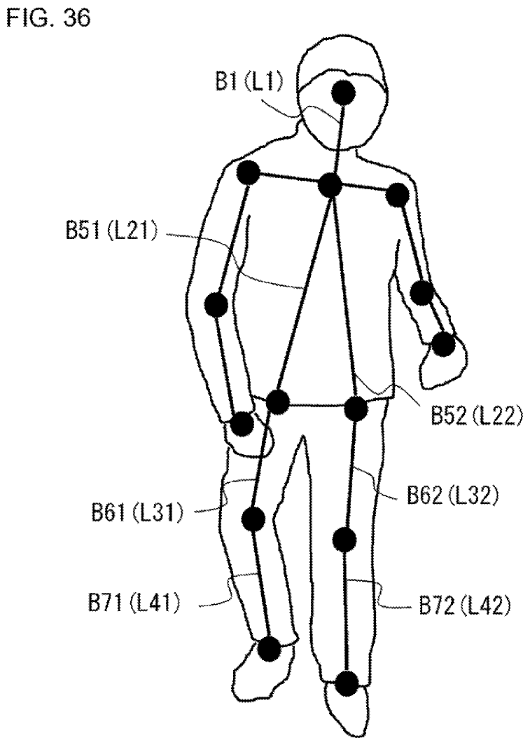

In an example in FIG. 36, the bone B1, the bone B51 and the bone B52, the bone B61 and the bone B62, and the bone B71 and the bone B72 are each detected without overlapping. L1+L21+L31+L41 and L1+L22+L32+L42 that are a total of the bones are acquired, and, for example, a value acquired by multiplying, by a correction constant, L1+L22+L32+L42 on a left leg side having a greater length of the detected bones is set as the height pixel number.

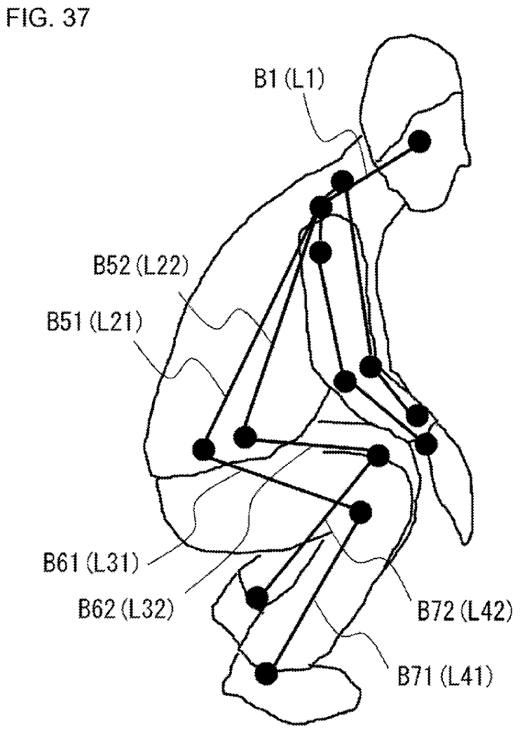

In an example in FIG. 37, the bone B1, the bone B51 and the bone B52, the bone B61 and the bone B62, and the bone B71 and the bone B72 are each detected, and the bone B61 and the bone B71 of a right leg and the bone B62 and the bone B72 of a left leg overlap. L1+L21+L31+L41 and L1+L22+L32+L42 that are a total of the bones are acquired, and, for example, a value acquired by multiplying, by a correction constant, L1+L21+L31+L41 on a right leg side having a greater length of the detected bones is set as the height pixel number.

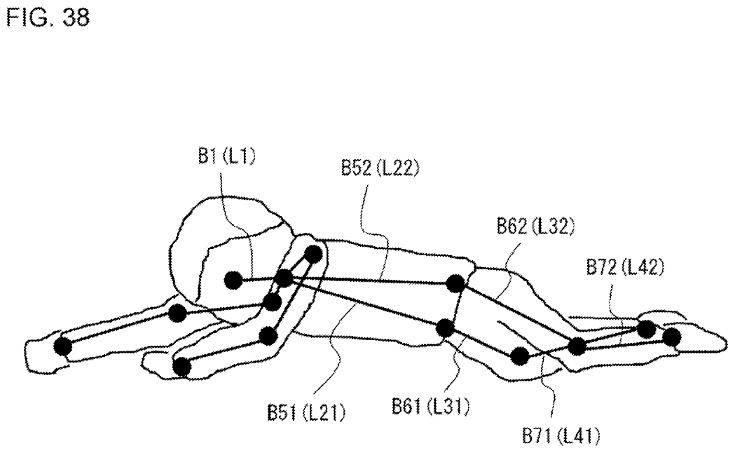

In an example in FIG. 38, the bone B1, the bone B51 and the bone B52, the bone B61 and the bone B62, and the bone B71 and the bone B72 are each detected, and the bone B61 and the bone B71 of the right leg and the bone B62 and the bone B72 of the left leg overlap. L1+L21+L31+L41 and L1+L22+L32+

L42 that are a total of the bones are acquired, and, for example, a value acquired by multiplying, by a correction constant, L1+L22+L32+L42 on the left leg side having a greater length of the detected bones is set as the height pixel number.

In the specific example 1, since a height can be acquired by adding up lengths of bones from a head to a foot, a height pixel number can be acquired by a simple method. Further, since at least a skeleton from a head to a foot may be able to be detected by a skeleton estimation technique using machine learning, a height pixel number can be accurately estimated even when the entire person is not necessarily captured in an image as in a squatting state and the like.

### Specific Example 2

In the specific example 2, a height pixel number is acquired by using a two-dimensional skeleton model indicating a relationship between a length of a bone included in a two-dimensional skeleton structure and a length of a whole body of a person on a two-dimensional image space.

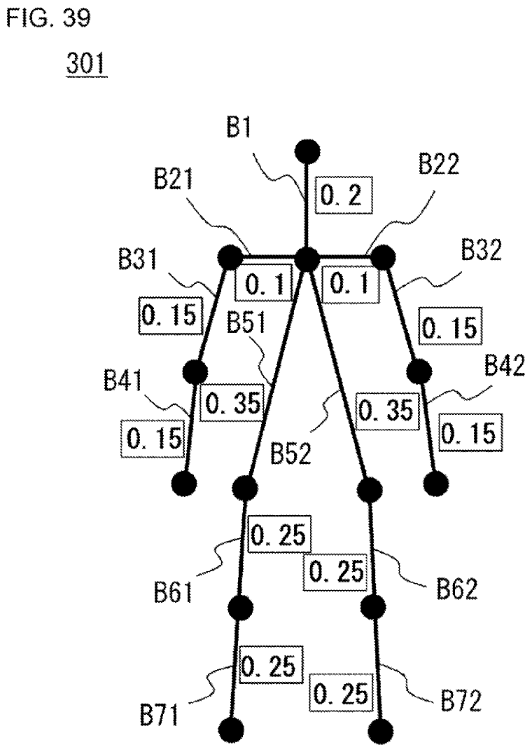

FIG. 39 is a human model (two-dimensional skeleton model) 301 that is used in the specific example 2 and indicates a relationship between a length of each bone on the two-dimensional image space and a length of a whole body on the two-dimensional image space. As illustrated in FIG. 39, a relationship between a length of each bone of an average person and a length of a whole body (a proportion of a length of each bone to a length of a whole body) is associated with each bone of the human model 301. For example, a length of the bone B1 of a head is the length of the whole body×0.2 (20%), a length of the bone B41 of a right hand is the length of the whole body×0.15 (15%), and a length of the bone B71 of the right leg is the length of the whole body×0.25 (25%). Information about such a human model 301 is stored in the database 201, and thus an average length of a whole body can be acquired from a length of each bone. In addition to a human model of an average person, a human model may be prepared for each attribute of a person such as age, gender, and nationality. In this way, a length (height) of a whole body can be appropriately acquired according to an attribute of a person.

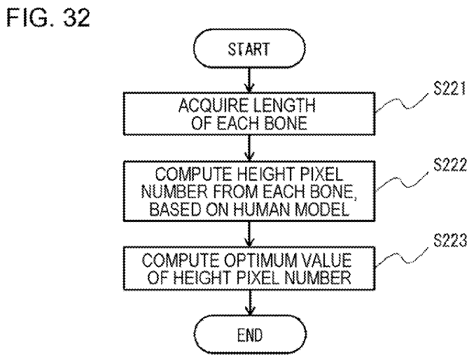

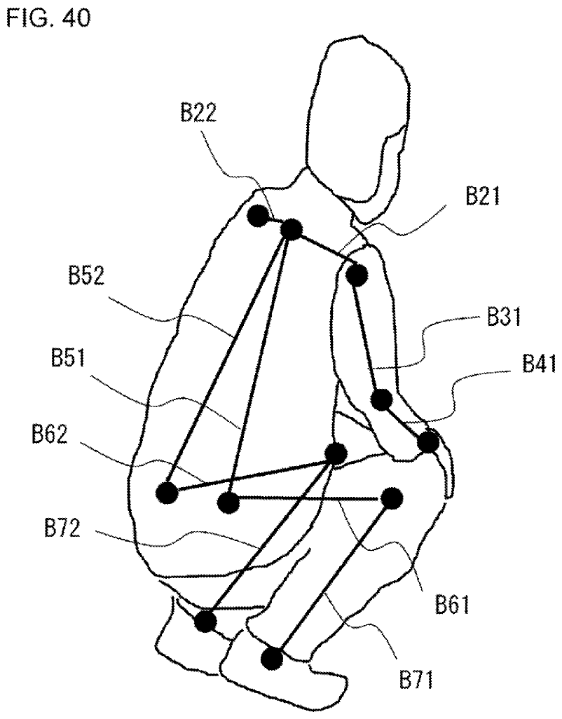

In the specific example 2, as illustrated in FIG. 32, the height computation unit 108 acquires a length of each bone (S221). The height computation unit 108 acquires a length of all bones (length on the two-dimensional image space) in a detected skeleton structure. FIG. 40 is an example of capturing a person in a squatting state diagonally from rear right and detecting a skeleton structure. In this example, since a face and a left side surface of a person are not captured, a bone of a head and bones of a left arm and a left hand cannot be detected. Thus, each length of bones B21, B22, B31, B41, B51, B52, B61, B62, B71, and B72 that are detected is acquired.

Subsequently, as illustrated in FIG. 32, the height computation unit 108 computes a height pixel number from a length of each bone, based on a human model (S222). The height computation unit 108 refers to the human model 301 indicating a relationship between lengths of each bone and a whole body as in FIG. 39, and acquires a height pixel number from the length of each bone. For example, since a length of the bone B41 of the right hand is the length of the whole body×0.15, a height pixel number based on the bone B41 is acquired from the length of the bone B41/0.15. Further, since a length of the bone B71 of the right leg is the length of the whole body×0.25, a height pixel number based on the bone B71 is acquired from the length of the bone B71/0.25.

The human model referred at this time is, for example, a human model of an average person, but a human model may be selected according to an attribute of a person such as age, gender, and nationality. For example, when a face of a person is captured in a captured image, an attribute of the person is identified based on the face, and a human model associated with the identified attribute is referred. An attribute of a person can be recognized from a feature of a face in an image by referring to information acquired by performing machine learning on a face for each attribute. Further, when an attribute of a person cannot be identified from an image, a human model of an average person may be used.

Further, a height pixel number computed from a length of a bone may be corrected by a camera parameter. For example, when a camera is placed in a high position and performs capturing in such a way that a person is looked down, a horizontal length such as a bone of a width of shoulders is not affected by a dip of the camera in a two-dimensional skeleton structure, but a vertical length such as a bone from a neck to a waist is reduced as a dip of the camera increases. Then, a height pixel number computed from the horizontal length such as a bone of a width of shoulders tends to be greater than an actual height pixel number. Thus, when a camera parameter is used, an angle at which a person is looked down by the camera is clear, and thus a correction can be performed in such a way as to acquire a two-dimensional skeleton structure captured from the front by using information about the dip. In this way, a height pixel number can be more accurately computed.

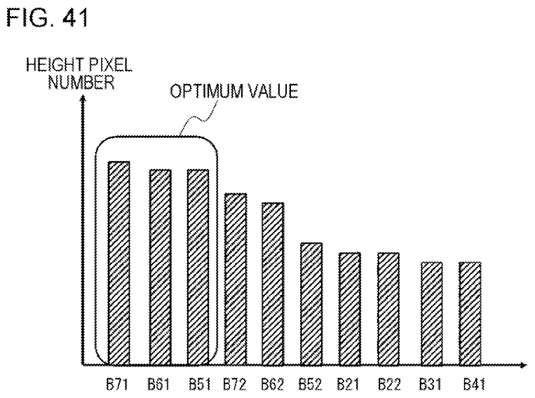

Subsequently, as illustrated in FIG. 32, the height computation unit 108 computes an optimum value of the height pixel number (S223). The height computation unit 108 computes an optimum value of the height pixel number from the height pixel number acquired for each bone. For example, a histogram of a height pixel number acquired for each bone as illustrated in FIG. 41 is generated, and a great height pixel number is selected from among the height pixel numbers. In other words, a longer height pixel number is selected from among a plurality of height pixel numbers acquired based on a plurality of bones. For example, top 30% is a valid value, and height pixel numbers by the bones B71, B61, and B51 are selected in FIG. 41. An average of the selected height pixel numbers may be acquired as an optimum value, or a greatest height pixel number may be set as an optimum value. Since a height is acquired from a length of a bone in a two-dimensional image, when the bone cannot be captured from the front, i.e., when the bone tilted in the depth direction as viewed from the camera is captured, a length of the bone is shorter than that captured from the front. Then, a value having a greater height pixel number has a higher possibility of being captured from the front than a value having a smaller height pixel number and is a more plausible value, and thus a greater value is set as an optimum value.

In the specific example 2, since a height pixel number is acquired based on a bone of a detected skeleton structure by using a human model indicating a relationship between lengths of a bone and a whole body on the two-dimensional image space, a height pixel number can be acquired from some of bones even when all skeletons from a head to a foot cannot be acquired. Particularly, a height pixel number can be accurately estimated by adopting a greater value among values acquired from a plurality of bones.

### Specific Example 3

In the specific example 3, a skeleton vector of a whole body is acquired by fitting a two-dimensional skeleton structure to a three-dimensional human model (three-dimensional skeleton model) and using a height pixel number of the fit three-dimensional human model.

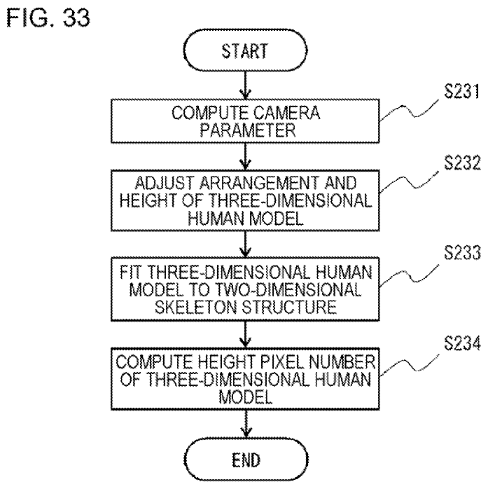

In the specific example 3, as illustrated in FIG. 33, the height computation unit 108 first computes a camera parameter, based on an image captured by the camera 200 (S231). The height computation unit 108 extracts an object whose length is clear in advance from a plurality of images captured by the camera 200, and acquires a camera parameter from a size (pixel number) of the extracted object. Note that, a camera parameter may be acquired in advance, and the acquired camera parameter may be acquired as necessary.

Subsequently, the height computation unit 108 adjusts an arrangement and a height of a three-dimensional human model (S232). The height computation unit 108 prepares, for a detected two-dimensional skeleton structure, the three-dimensional human model for a height pixel number computation, and arranges the three-dimensional human model in the same two-dimensional image, based on the camera parameter. Specifically, a “relative positional relationship between a camera and a person in a real world” is determined from the camera parameter and the two-dimensional skeleton structure. For example, if a position of the camera has coordinates (0, 0, 0), coordinates (x, y, z) of a position in which a person stands (or sits) are determined. Then, by assuming an image captured when the three-dimensional human model is arranged in the same position (x, y, z) as that of the determined person, the two-dimensional skeleton structure and the three-dimensional human model are superimposed.

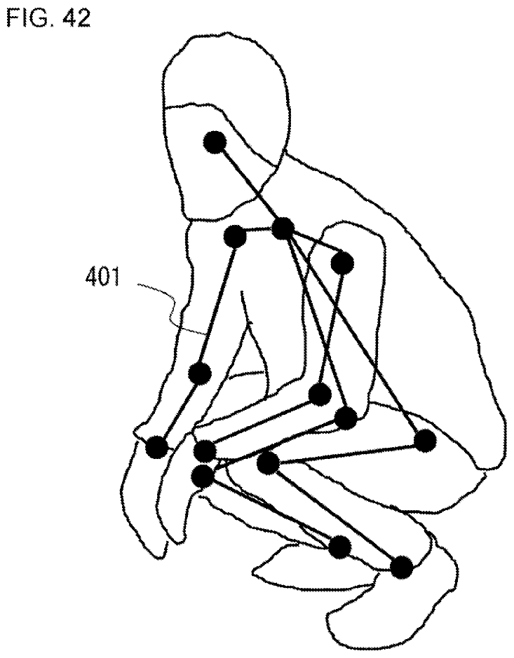

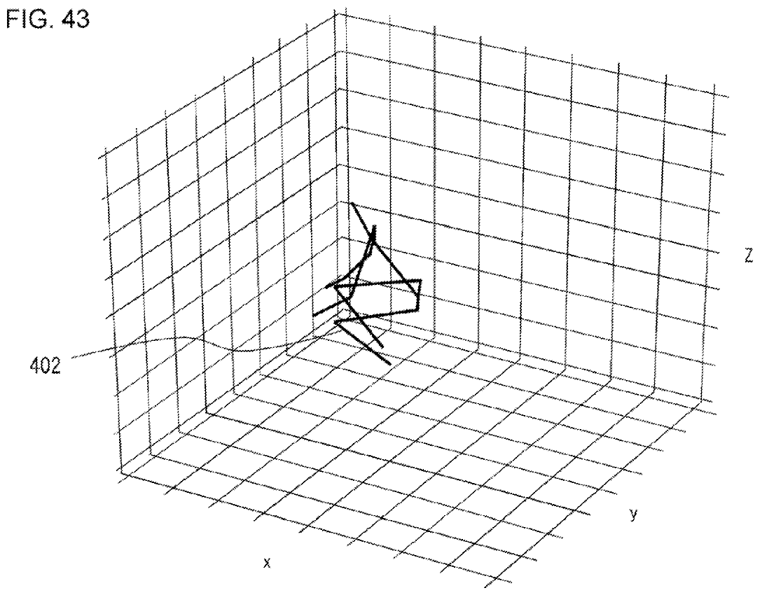

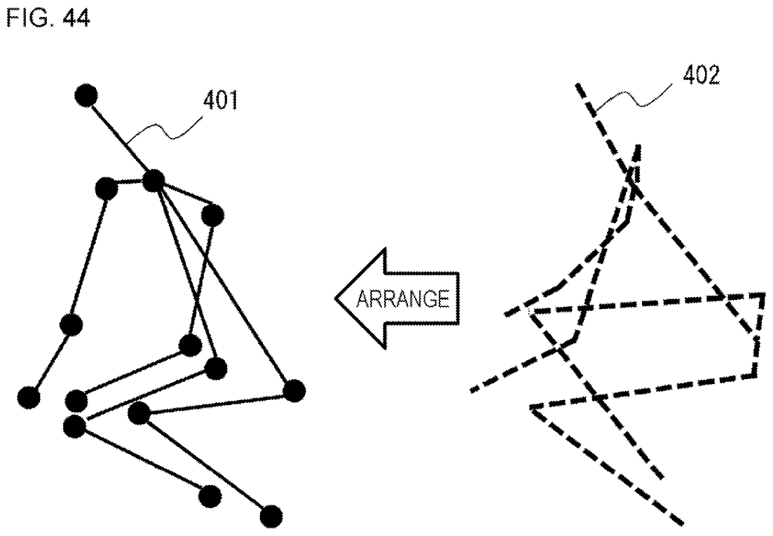

FIG. 42 is an example of capturing a squatting person diagonally from front left and detecting a two-dimensional skeleton structure 401. The two-dimensional skeleton structure 401 includes two-dimensional coordinate information. Note that, all bones are preferably detected, but some of bones may not be detected. A three-dimensional human model 402 as in FIG. 43 is prepared for the two-dimensional skeleton structure 401. The three-dimensional human model (three-dimensional skeleton model) 402 is a model of a skeleton including three-dimensional coordinate information and having the same shape as that of the two-dimensional skeleton structure 401. Then, as in FIG. 44, the prepared three-dimensional human model 402 is arranged and superimposed on the detected two-dimensional skeleton structure 401. Further, the three-dimensional human model 402 is superimposed on the two-dimensional skeleton structure 401, and a height of the three-dimensional human model 402 is also adjusted to the two-dimensional skeleton structure 401.

Note that, the three-dimensional human model 402 prepared at this time may be a model in a state close to a pose of the two-dimensional skeleton structure 401 as in FIG. 44, or may be a model in an upright state. For example, the three-dimensional human model 402 with an estimated pose may be generated by using a technique for estimating a pose in a three-dimensional space from a two-dimensional image by using machine learning. A three-dimensional pose can be estimated from a two-dimensional image by learning information about a joint in the two-dimensional image and information about a joint in a three-dimensional space.

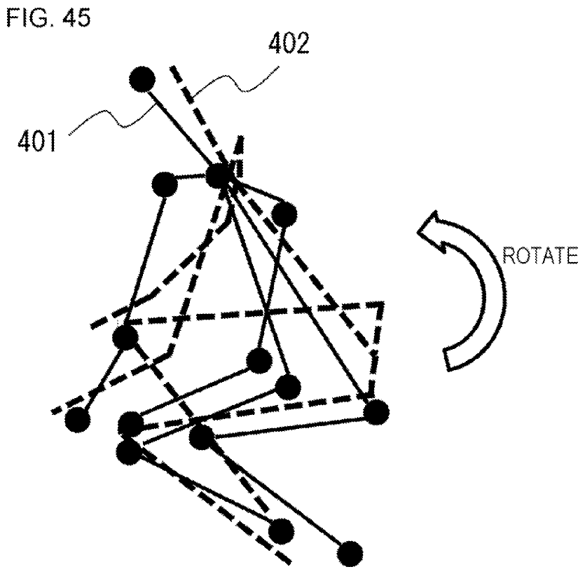

Subsequently, as illustrated in FIG. 33, the height computation unit 108 fits the three-dimensional human model to a two-dimensional skeleton structure (S233). As in FIG. 45, the height computation unit 108 deforms the three-dimensional human model 402 in such a way that poses of the three-dimensional human model 402 and the two-dimensional skeleton structure 401 match in a state where the three-dimensional human model 402 is superimposed on the two-dimensional skeleton structure 401. In other words, a height, an orientation of a body, and an angle of a joint of the three-dimensional human model 402 are adjusted, and optimization is performed in such a way as to eliminate a difference from the two-dimensional skeleton structure 401. For example, by rotating a joint of the three-dimensional human model 402 in a movable range of a person and also rotating the entire three-dimensional human model 402, the entire size is adjusted. Note that, fitting (application) between a three-dimensional human model and a two-dimensional skeleton structure is performed on a two-dimensional space (two-dimensional coordinates). In other words, a three-dimensional human model is mapped to the two-dimensional space, and the three-dimensional human model is optimized for a two-dimensional skeleton structure in consideration of a change of the deformed three-dimensional human model in the two-dimensional space (image).

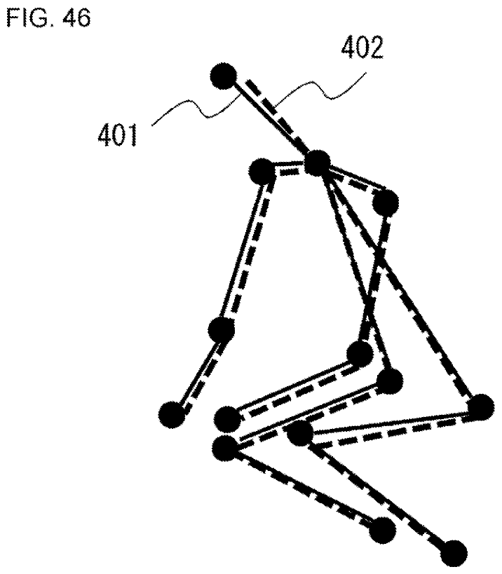

Subsequently, as illustrated in FIG. 33, the height computation unit 108 computes a height pixel number of the fit three-dimensional human model (S234). As in FIG. 46, when there is no difference between the three-dimensional human model 402 and the two-dimensional skeleton structure 401 and poses match, the height computation unit 108 acquires a height pixel number of the three-dimensional human model 402 in that state. With the optimized three-dimensional human model 402 in an upright state, a length of a whole body on the two-dimensional space is acquired based on a camera parameter. For example, a height pixel number is computed from lengths (pixel numbers) of bones from a head to a foot when the three-dimensional human model 402 is upright. Similarly to the specific example 1, the lengths of the bones from the head to the foot of the three-dimensional human model 402 may be added up.

In the specific example 3, a height pixel number is acquired based on a three-dimensional human model by fitting the three-dimensional human model to a two-dimensional skeleton structure, based on a camera parameter, and thus the height pixel number can be accurately estimated even when all bones are not captured at the front, i.e., when an error is great due to all bones being captured on a slant.

### <Normalization Processing>

As illustrated in FIG. 30, the image processing apparatus 100 performs the normalization processing (S202) subsequent to the height pixel number computation processing. In the normalization processing, as illustrated in FIG. 34, the feature data extraction unit 103 computes a keypoint height (S241). The feature data extraction unit 103 computes a keypoint height (pixel number) of all keypoints included in the detected skeleton structure. The keypoint height is a length (pixel number) in the height direction from a lowest end (for example, a keypoint of any foot) of the skeleton structure to the keypoint. Herein, as one example, the keypoint height is acquired from a Y coordinate of the keypoint in an image. Note that, as described above, the keypoint height may be acquired from a length in a direction along a vertical projection axis based on a camera parameter. For example, in the example in FIG. 35, a height (vi) of a keypoint A2 of a neck is a value acquired by subtracting a Y coordinate of a keypoint A81 of a right foot or a keypoint A82 of a left foot from a Y coordinate of the keypoint A2.

Subsequently, the feature data extraction unit 103 determines a reference point for normalization (S242). The reference point is a point being a reference for representing a relative height of a keypoint. The reference point may be preset, or may be able to be selected by a user. The reference point is preferably at the center of the skeleton structure or higher than the center (in an upper half of an image in the up-down direction), and, for example, coordinates of a keypoint of a neck are set as the reference point. Note that, coordinates of a keypoint of a head or another portion instead of a neck may be set as the reference point. Instead of a keypoint, any coordinates (for example, center coordinates in the skeleton structure, and the like) may be set as the reference point.

Subsequently, the feature data extraction unit 103 normalizes the keypoint height (yi) by the height pixel number (S243). The feature data extraction unit 103 normalizes each keypoint by using the keypoint height of each keypoint, the reference point, and the height pixel number. Specifically, the feature data extraction unit 103 normalizes, by the height pixel number, a relative height of a keypoint with respect to the reference point. Herein, as an example focusing only on the height direction, only a Y coordinate is extracted, and normalization is performed with the reference point as the keypoint of the neck. Specifically, with a Y coordinate of the reference point (keypoint of the neck) as (yc), feature data (normalization value) are acquired by using the following equation (1). Note that, when a vertical projection axis based on a camera parameter is used, (yi) and (yc) are converted into values in a direction along the vertical projection axis.

$$[ Mathematical 1 ]$$

$${f}_{i} = ( {y}_{i} - {y}_{c} ) / h \qquad ( 1 )$$

For example, when the number of keypoints is 18, 18 coordinates (x0, y0), (x1, y1), . . . and (x17, y17) of the keypoints are converted into 18-dimensional feature data as follows by using the equation (1) described above.

$$[ Mathematical 2 ]$$

$${f}_{0} = ( {y}_{0} - {y}_{c} ) / h \\ {f}_{1} = ( {y}_{1} - {y}_{c} ) / h \\ ⋮ \\ {f}_{17} = ( {y}_{17} - {y}_{c} ) / h \qquad ( 2 )$$

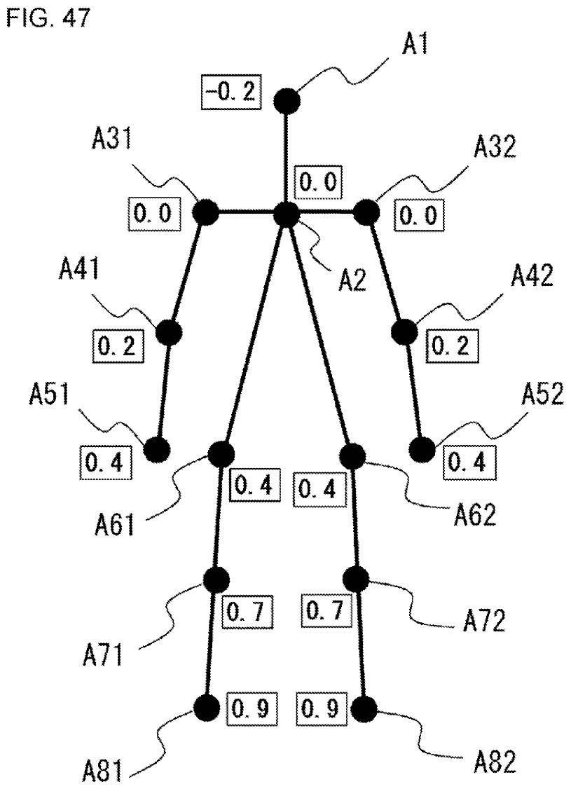

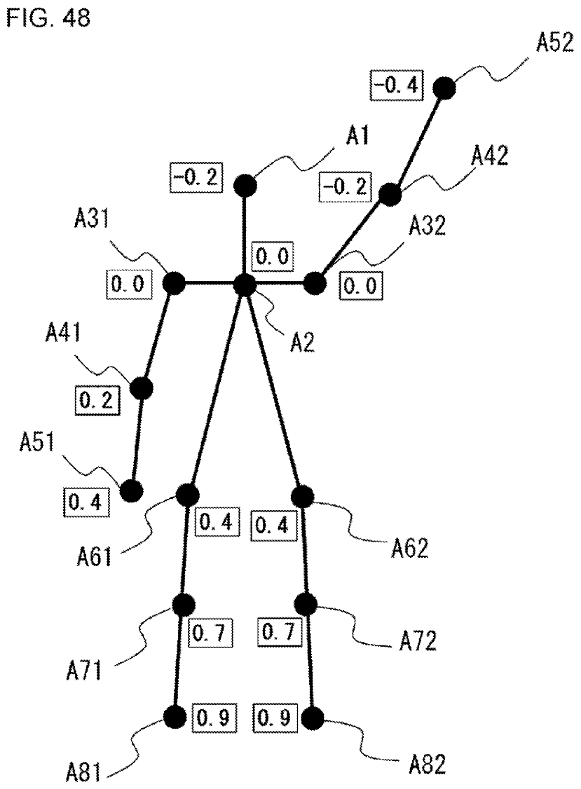

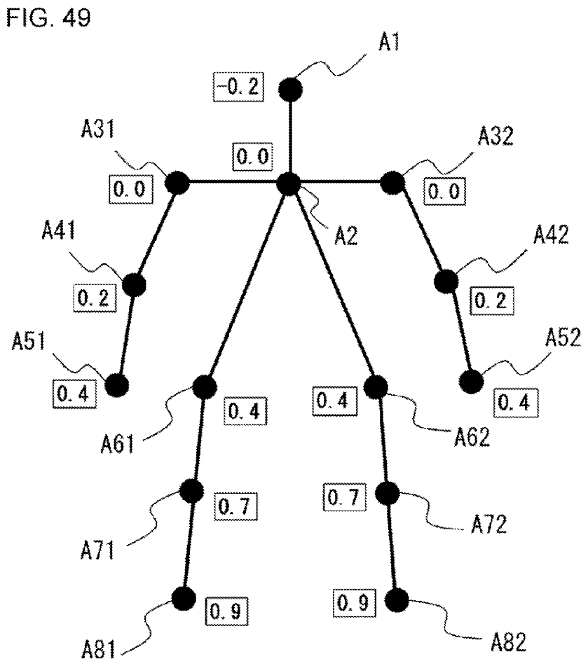

FIG. 47 illustrates an example of feature data about each keypoint acquired by the feature data extraction unit 103. In this example, since the keypoint A2 of the neck is the reference point, feature data about the keypoint A2 are 0.0 and feature data about a keypoint A31 of a right shoulder and a keypoint A32 of a left shoulder at the same height as the neck are also 0.0. Feature data about a keypoint A1 of a head higher than the neck are −0.2. Feature data about a keypoint A51 of a right hand and a keypoint A52 of a left hand lower than the neck are 0.4, and feature data about the keypoint A81 of the right foot and the keypoint A82 of the left foot are 0.9. When the person raises the left hand from this state, the left hand is higher than the reference point as in FIG. 48, and thus feature data about the keypoint A52 of the left hand are −0.4. Meanwhile, since normalization is performed by using only a coordinate of the Y axis, as in FIG. 49, feature data do not change as compared to FIG. 47 even when a width of the skeleton structure changes. In other words, feature data (normalization value) according to the present example embodiment indicate a feature of a skeleton structure (keypoint) in the height direction (Y direction), and is not affected by a change of the skeleton structure in the horizontal direction (X direction).

As described above, in the present example embodiment, a skeleton structure of a person is detected from a two-dimensional image, and each keypoint of the skeleton structure is normalized by using a height pixel number (upright height on a two-dimensional image space) acquired from the detected skeleton structure. Robustness when classification, a search, and the like are performed can be improved by using the normalized feature data. In other words, since feature data according to the present example embodiment are not affected by a change of a person in the horizontal direction as described above, robustness with respect to a change in orientation of the person and a body shape of the person is great.

Furthermore, the present example embodiment can be achieved by detecting a skeleton structure of a person by using a skeleton estimation technique such as OpenPose, and thus learning data that learn a pose and the like of a person do not need to be prepared. Further, classification and a search of a pose and the like of a person can be achieved by normalizing a keypoint of a skeleton structure and storing the keypoint in advance in a database, and thus classification and a search can also be performed on an unknown pose. Further, clear and simple feature data can be acquired by normalizing a keypoint of a skeleton structure, and thus persuasion of a user for a processing result is high unlike a black box algorithm as in machine learning.

A part or the whole of the above-described example embodiment may also be described in supplementary notes below, which is not limited thereto.
1. A driver surveillance apparatus including:
   an image acquisition unit that acquires an image in which a driver of a moving body is captured;
   a first detection unit that extracts feature data about a body of the driver captured in the image, verifies the extracted feature data with reference data, and thus detects at least one of a predetermined pose and a predetermined movement;
   a second detection unit that detects a predetermined object from the image; and
   a third detection unit that detects predetermined behavior of the driver, based on a detection result of at least one of the predetermined pose and the predetermined movement and a detection result of the predetermined object.
2. The driver surveillance apparatus according to supplementary note 1, wherein the first detection unit detects a keypoint of a body of the driver, and extracts the feature data, based on the detected keypoint.
3. The driver surveillance apparatus according to supplementary note 1 or 2, wherein
   the third detection unit detects the predetermined behavior by the driver, based on predetermined behavior information in which a combination of at least one of a predetermined pose and a predetermined movement and the predetermined object is associated with each of a plurality of pieces of the predetermined behavior.
4. The driver surveillance apparatus according to any of supplementary notes 1 to 3, further including
   a storage unit that stores the reference data, wherein
   the first detection unit verifies the extracted feature data with the reference data stored in the storage unit.
5. The driver surveillance apparatus according to supplementary note 4, further including
   an update unit that receives an input of the additional reference data, and stores the reference data in the storage unit.
6. The driver surveillance apparatus according to any of supplementary notes 1 to 5, further including:
   a correct/incorrect input reception unit that outputs, when the predetermined behavior of the driver is detected, information indicating the detection to a user, and receives a user input indicating whether an output content is correct; and
   a transmission unit that transmits, to an external server, the image used for the detection of the predetermined behavior as an image indicating the predetermined behavior when the user input indicating that the output content is correct is received.
7. The driver surveillance apparatus according to any of supplementary notes 1 to 6, further including
   a sensor data acquisition unit that acquires data generated by a sensor mounted on the moving body, wherein
   the third detection unit detects the predetermined behavior of the driver, based on a detection result of at least one of the predetermined pose and the predetermined movement, a detection result of the predetermined object, and data generated by the sensor.
8. The driver surveillance apparatus according to supplementary note 7, wherein
   the third detection unit detects the predetermined behavior of the driver when the driver does not hold a handle of the moving body with both hands.
9. The driver surveillance apparatus according to any of supplementary notes 1 to 8, wherein
   the driver surveillance apparatus is a vehicle-mounted apparatus.
10. A driver surveillance method executed by a computer, the driver surveillance method including:
   an image acquisition step of acquiring an image in which a driver of a moving body is captured;
   a first detection step of extracting feature data about a body of the driver captured in the image, verifying the extracted feature data with reference data, and thus detecting at least one of a predetermined pose and a predetermined movement;
   a second detection step of detecting a predetermined object from the image; and
   a third detection step of detecting predetermined behavior of the driver, based on a detection result of at least one of the predetermined pose and the predetermined movement and a detection result of the predetermined object.
11. A program causing a computer to function as:
   an image acquisition unit that acquires an image in which a driver of a moving body is captured;
   a first detection unit that extracts feature data about a body of the driver captured in the image, verifies the extracted feature data with reference data, and thus detects at least one of a predetermined pose and a predetermined movement;
   a second detection unit that detects a predetermined object from the image; and
   a third detection unit that detects predetermined behavior of the driver, based on a detection result of at least one of the predetermined pose and the predetermined movement and a detection result of the predetermined object.

### REFERENCE SIGNS LIST

1 Image processing system
1000 Image processing apparatus
1001 Skeleton detection unit
1002 Feature data extraction unit
1003 Recognition unit
100 Image processing apparatus
101 Image acquisition unit
102 Skeleton structure detection unit
103 Feature data extraction unit
104 Classification unit
105 Search unit
106 Input unit
107 Display unit
108 Height computation unit
109 Query acquisition unit
110 Change computation unit
111 Search unit
112 Query frame selection unit
10 Driver surveillance apparatus
11 Image acquisition unit
12 First detection unit
13 Second detection unit
14 Third detection unit
15 Storage unit
16 Update unit
17 Correct/incorrect input reception unit
18 Transmission unit
200 Camera
201 Database
300, 301 Human model
401 Two-dimensional skeleton structure

What is claimed is:

1. A driver surveillance apparatus comprising:
at least one memory configured to store one or more instructions; and
at least one processor configured to execute the one or more instructions to:
acquire an image in which a driver of a moving body is captured;
extract feature data about a body of the driver captured in the image, verify the extracted feature data with reference data, and thus detect at least one of a predetermined pose and a predetermined movement;
detect a predetermined object from the image; and
detect predetermined behavior of the driver, based on a detection result of at least one of the predetermined pose and the predetermined movement and a detection result of the predetermined object.

2. The driver surveillance apparatus according to claim 1, wherein
the at least one processor is further configured to execute the one or more instructions to detect a keypoint of a body of the driver, and extract the feature data, based on the detected keypoint.

3. The driver surveillance apparatus according to claim 1, wherein
the at least one processor is further configured to execute the one or more instructions to detect the predetermined behavior by the driver, based on predetermined behavior information in which a combination of at least one of a predetermined pose and a predetermined movement and the predetermined object is associated with each of a plurality of pieces of the predetermined behavior.

4. The driver surveillance apparatus according to claim 1, wherein the at least one processor is further configured to execute the one or more instructions to
store the reference data, and
verify the extracted feature data with the reference data stored in the storage unit.

5. The driver surveillance apparatus according to claim 4, wherein
the at least one processor is further configured to execute the one or more instructions to receive an input of the additional reference data, and store the reference data.

6. The driver surveillance apparatus according to claim 1, wherein the at least one processor is further configured to execute the one or more instructions to
output, when the predetermined behavior of the driver is detected, information indicating the detection to a user, and receive a user input indicating whether an output content is correct; and
transmit, to an external server, the image used for the detection of the predetermined behavior as an image indicating the predetermined behavior when the user input indicating that the output content is correct is received.

7. The driver surveillance apparatus according to claim 1, wherein the at least one processor is further configured to execute the one or more instructions to
acquire data generated by a sensor mounted on the moving body, and
detect the predetermined behavior of the driver, based on a detection result of at least one of the predetermined pose and the predetermined movement, a detection result of the predetermined object, and data generated by the sensor.

8. The driver surveillance apparatus according to claim 7, wherein
the at least one processor is further configured to execute the one or more instructions to detect the predetermined behavior of the driver when the driver does not hold a handle of the moving body with both hands.

9. The driver surveillance apparatus according to claim 1,
wherein the driver surveillance apparatus is a vehicle-mounted apparatus.

10. A driver surveillance method executed by a computer, the driver surveillance method comprising:
acquiring an image in which a driver of a moving body is captured;
extracting feature data about a body of the driver captured in the image, verifying the extracted feature data with reference data, and thus detecting at least one of a predetermined pose and a predetermined movement;
detecting a predetermined object from the image; and
detecting predetermined behavior of the driver, based on a detection result of at least one of the predetermined pose and the predetermined movement and a detection result of the predetermined object.

11. A non-transitory storage medium storing a program causing a computer to:
acquire an image in which a driver of a moving body is captured;
extract feature data about a body of the driver captured in the image, verify the extracted feature data with reference data, and thus detect at least one of a predetermined pose and a predetermined movement;
detect a predetermined object from the image; and
detect predetermined behavior of the driver, based on a detection result of at least one of the predetermined pose and the predetermined movement and a detection result of the predetermined object.

12. The driver surveillance method according to claim 10, wherein
the computer detects a keypoint of a body of the driver, and extracts the feature data, based on the detected keypoint.

13. The driver surveillance method according to claim 10, wherein
the computer detects the predetermined behavior by the driver, based on predetermined behavior information in which a combination of at least one of a predetermined pose and a predetermined movement and the predetermined object is associated with each of a plurality of pieces of the predetermined behavior.

14. The driver surveillance method according to claim 10, the computer
stores the reference data, and
verifies the extracted feature data with the reference data stored in the storage unit.

15. The driver surveillance method according to claim 14, wherein
the computer receives an input of the additional reference data, and stores the reference data.

16. The driver surveillance method according to claim 10, wherein the computer
outputs, when the predetermined behavior of the driver is detected, information indicating the detection to a user, and receives a user input indicating whether an output content is correct; and
transmits, to an external server, the image used for the detection of the predetermined behavior as an image indicating the predetermined behavior when the user input indicating that the output content is correct is received.

17. The non-transitory storage medium according to claim 11, wherein
the program causing the computer to detect a keypoint of a body of the driver, and extract the feature data, based on the detected keypoint.

18. The non-transitory storage medium according to claim 11, wherein
the program causing the computer to detect the predetermined behavior by the driver, based on predetermined behavior information in which a combination of at least one of a predetermined pose and a predetermined movement and the predetermined object is associated with each of a plurality of pieces of the predetermined behavior.

19. The non-transitory storage medium according to claim 11, wherein the program causing the computer to
store the reference data, and
verify the extracted feature data with the reference data stored in the storage unit.

20. The non-transitory storage medium according to claim 19, wherein the program causing the computer to
receive an input of the additional reference data, and store the reference data.
